(19) United States
(12) Patent Application Publication
(10) Pub. No.: US 2020/0394651 A1
(43) Pub. Date: Dec. 17, 2020

(54) DYNAMIC OFF-CHAIN DIGITAL CURRENCY TRANSACTION PROCESSING

(71) Applicant: GRIDPLUS, INC., AUSTIN, TX (US)

(72) Inventors: KARL J. KREDER, III, AUSTIN, TX (US); ALEXANDER SCOT MILLER, AUSTIN, TX (US); JOHN R. BOYD, IV, AUSTIN, TX (US)

(21) Appl. No.: 16/440,870

(22) Filed: Jun. 13, 2019

(51) Int. Cl. G06Q 20/38; G06Q 20/40

(52) U.S. Cl. CPC G06Q 20/389; G06Q 20/405; G06Q 2220/00; G06Q 20/38215; G06Q 20/3827; G06Q 20/3829

(57) ABSTRACT

A system enables cryptocurrency payment transactions between devices using off-chain asset data that is related to blockchain assets within a blockchain but without committing the payment transaction to the blockchain until a later time. A device selects a settlement model to determine if a payment transaction is valid. When valid, the device adjusts a value of off-chain asset data stored in its memory. The device may aggregate multiple transactions, which may involve the same or different cryptocurrencies, adjusting the value of the off-chain asset data stored in its memory after each transaction. Subsequently, the device may commit at least a portion of the off-chain asset data to the blockchain.

### INCORPORATION BY REFERENCE

U.S. patent application Ser. No. 16/057,290 filed Aug. 7, 2018 and titled “System for Secure Storage of Cryptographic Keys” is hereby incorporated by reference in its entirety.

### BACKGROUND

A cryptocurrency is a digital asset designed to work as a medium of exchange that uses cryptography to secure transactions, control the creation of digital assets, and verify the transfer of assets. Unlike conventional, centralized currency and central banking systems, cryptocurrencies typically utilize a decentralized processing through a distributed ledger technology, such as a blockchain, that serves as a public transaction database.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 depicts a diagram of a cryptocurrency asset transaction in which blockchain asset data is downloaded and stored on a device as off-chain asset data, and used to conduct payment transactions with other devices, according to one implementation.

FIG. 2 depicts a system that utilizes a device to conduct payment transactions based on off-chain asset data through a point-of-sale (POS) payment terminal, according to one implementation.

FIG. 3 depicts a system including a secure payment terminal to facilitate downloading of blockchain asset data to one or more devices that store off-chain asset data, according to one implementation.

FIG. 4 depicts a block diagram of a secure payment terminal of FIGS. 1 and 3, according to one possible implementation.

FIG. 5 depicts a block diagram of a computing device with a mobile wallet that may be used with the systems of FIGS. 1 through 3, according to one possible implementation.

FIG. 6 depicts a block diagram of a device that may be used with the systems of FIGS. 1 through 3, according to one implementation.

FIG. 7 illustrates blockchain data, download of blockchain asset data for storage in a device as off-chain asset data, transfer of off-chain asset data between devices, and redemption of off-chain asset data to the blockchain according to one possible implementation.

FIG. 8 depicts a flow diagram of a process of conducting a payment transaction between devices using off-chain asset data, according to one implementation.

FIG. 9 depicts a diagram of a process of downloading blockchain asset data, storing the blockchain asset data as off-chain asset data in a device, using the device, and subsequently redeeming the off-chain asset data from the device to the blockchain, according to one possible implementation.

FIG. 10 depicts a flow diagram of a process of conducting an off-chain digital currency transaction between devices using a key-based settlement model, according to one implementation.

FIG. 11 depicts a flow diagram of a process of conducting an off-chain digital currency transaction between devices using an unspent transaction output (UTXO) settlement model, according to one implementation.

FIG. 12 depicts a flow diagram of a process of conducting an off-chain digital currency transaction between devices using an account settlement model, according to one implementation.

FIG. 13 depicts a flow diagram of a process of conducting an off-chain digital currency transaction between devices using an authority-based settlement model, according to one implementation.

FIG. 14 depicts a flow diagram of a process of conducting an off-chain digital currency transaction between devices using a proof-based settlement model, according to one implementation.

While implementations are described herein by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

### DETAILED DESCRIPTION

Cryptocurrencies based on distributed peer-to-peer systems for transacting value are becoming more and more ubiquitous. The peer-to-peer systems (sometimes referred to as “blockchain servers” may store blockchain assets in a distributed ledger, sometimes referred to as a blockchain or blockchain data. The blockchain includes a sequenced series records of economic transactions that are managed by multiple distributed computer servers that are not owned by any single entity. Each block of data in the blockchain is secured and bound to a preceding block of data in the blockchain by use of a hash pointer to the preceding block. Each block of data in the blockchain includes one or more blockchain assets, other data, and a hash pointer to the preceding block. The hash pointer includes an address of the previous block and a compressed version of the data contained in the previous block, known as a block header. Certain participants in a blockchain may choose to create blocks by validating transactions and including them in a new block via a consensus mechanism, such as a proof of work mechanism, a proof of stake mechanism, or another consensus mechanism. A proof of work mechanism may rely on the computational complexity involved in mining a cryptographic block of data with requisite hash values and pointer values linking the block to the existing chain as proof of the validity of the block. The consensus mechanism is a fault-tolerant mechanism used in blockchain systems to achieve agreement on a single data value or a state of the blockchain among distributed processes and systems. One or more of the participants in the blockchain may validate transactions and include them in a new block via the consensus mechanism, creating a unique record with a unique history. Falsifying a single record of the blockchain would require falsifying the data of a block and then falsifying every single block afterward, which would be considered infeasible due to the resources needed to manipulate consensus.

The peer-to-peer blockchain servers may commit cryptocurrency transactions according to a consensus protocol for the particular cryptocurrency. The consensus protocol allows the blockchain servers to resolve the existence of multiple copies of the blockchain in favor of a canonical copy based upon the consensus rules (a consensus among the blockchain servers about which version of the blockchain is valid). For cryptocurrencies such as Bitcoin and Ethereum, the blockchain servers may use a proof-of-work consensus model. In the proof-of-work consensus model, computers may “prove” that they have performed “work” by solving a complex computational math problem called a hash. If a computer solves such a problem by “hashing” a block of data, its algorithmic work will have also verified the block's transactions, and the completed transaction is publicly recorded and stored as a block in the blockchain. Adding blocks to the blockchain may be called “mining.” Solving such complex math problems requires the computer to run programs that cost significant amounts of power and energy, which creates an economic incentive for cooperation in a Byzantine environment. The Byzantine environment refers to a distributed computing system of computing devices that have imperfect information about one another.

These cryptocurrency systems may utilize digital signatures to sign messages that, if validly signed, would result in updates to the distributed ledger that indicate transfers of tokens (digital currency value) from one account to another. At any given time, a token's movement is encumbered by a requirement which in its simplest form is a cryptographic signature from a private key associated with a permutation of the public key (account or address) to which the token is encumbered. In some implementations, tokens may be used to represent assets. Blockchains provide for a decentralized, distributed trustless system allowing participants to transfer value, participate in smart contracts, and so forth. For example, cryptocurrencies, such as Bitcoin, Ethereum, Iota, Zcash, Monero, Cardano, and so forth, utilize blockchains to operate. Digital cryptographic signatures (signatures) are used to determine if a message describing a proposed transaction is authentic, and whether the transaction is valid. A message is deemed to be authentic if the corresponding signature was produced using one or more private key(s). A transaction is deemed to be valid if the key pair is associated with a balance or privilege, as indicated in the global ledger, that is sufficient to execute the transaction.

For example, a message describing a transaction may be digitally signed with a private key using a cryptographic function. The private key is intended to remain known only by the party authorized to permit the transaction. Continuing the example, a message describing a transaction to transfer a specific amount of cryptocurrency from a source address that is derived from the signer's public key to a destination address may be digitally signed by the holder of the source private key. For example, the specific amount of cryptocurrency may be a portion of a blockchain asset. The message may then be sent to one or more blockchain servers. A blockchain server may receive the message, and check (verify) the digital signature. If the digital signature is valid and the transaction conforms to the blockchain rules, the blockchain server may process the message and commit the data in the message into the blockchain, which may update the balance or privilege associated with the authorized party's private key and which may also update the balance or privilege associated with the destination address (an address associated with the recipient of the digital currency in the committed transaction). In some situations, the blockchain system may perform various checks prior to committing the data, such as waiting until a consensus among other blockchain servers has been reached. These checks may establish a shared set of conditions and are outside the scope of the signature itself.

Described in this disclosure are devices such as smart cards, secure payment terminals, portable computing devices (such as smartphones, laptops, tablet computers, and so on), and other devices that allow for highly secure storage and use of secrets, such as private keys, to exchange off-chain asset data (blockchain asset data that is downloaded from the blockchain), to validate payment transactions using the off-chain asset data (such as payments from different types of accounts), and to complete the payment transaction off-chain.

It should be understood that there is a distinction between “off-line” and “off-chain.” An off-line transaction is conducted without a connection to a network, such as the Internet. An off-chain transaction may be conducted while connected to the Internet (while on-line) or while off-line, depending on the particular transaction. As used herein, the term “off-chain” is used to refer to a payment transaction that exchanges asset data without recording the transaction to the blockchain. The term “off-chain asset data” refers to a digital currency balance and/or one or more pieces of data which may be used to unencumber on-chain assets that are stored on a device, such as a smart card, a smartphone, or another computing device that is not a blockchain server.

Devices are described below that may resolve (validate and complete) a payment transaction that includes off-chain asset data without committing the off-chain transaction data to the blockchain. Instead, off-chain asset data and other data may be exchanged between the devices, and the receiving device may validate the off-chain asset data using one of a plurality of settlement models. Additionally, the transactional rules of consensus may be enforced by the software running on the devices. In some of the settlement models, the device that receives a payment transaction may query the blockchain to verify a portion of the payment transaction, such as the existence of a blockchain asset in the blockchain that corresponds to data in the payment transaction. For example, based on a first settlement model, the receiving device may query the blockchain based on a portion of the payment transaction to determine a blockchain asset, without committing the payment transaction to the blockchain. In response to determining the blockchain asset, the settlement model may be used to verify payment information in the payment transaction and to adjust a value of off-chain asset data in memory of the device based on the payment information. For example, the device may use the settlement model to determine the payment transaction is valid based on information included in the payment transaction, such as a payment amount, a blockchain transaction identifier (ID), a public key, or other information. The device may already include off-chain asset data stored in its memory and, in response to determining the payment transaction is valid, the device may adjust a value of the off-chain asset data in its memory.

For example, a second device may resolve a payment transaction including a portion of the off-chain asset data of a first device without committing the payment transaction to the blockchain, based on data included in the payment transaction that is indicative of a blockchain asset in the blockchain. Thus, the devices may be used to exchange cryptocurrency, in real-time or near real-time, without incurring blockchain transaction fees.

For example, a device may store off-chain asset data indicative of blockchain asset data that is transferred from a blockchain asset in the blockchain. The blockchain asset data may include a transaction identifier (ID) or transaction hash associated with the blockchain asset in the blockchain. A user may utilize the device to conduct one or more payment transactions that utilize the off-chain asset data, off-chain. Such transactions may include sending payments, receiving payments, or both, through a network. Subsequently, the user may couple the device to a secure payment terminal (or to another device) and may utilize the network connection of the secure payment terminal or other device to send a signed message to one or more blockchain servers to commit at least a portion of the off-chain asset data to the blockchain. The off-chain asset data may include payment information from one or more payment transactions, downloaded blockchain asset data, or any combination thereof. Thus, instead of committing each individual payment transaction to the blockchain, incurring transaction costs for each transaction, multiple “off-chain” transactions may be aggregated by the device and committed to the blockchain in a single transaction, incurring a one-time transaction fee.

In some implementations, the systems and methods may include a secure payment terminal. The secure payment terminal may include a general computing environment (GCE) and a separate, secure computing environment (SCE), as well as a second SCE which may be a smart card. The SCE may implement one or more controls over access to its memory and use of information stored in its memory. The SCE may also include modules, components, and data that may be used to secure data and functionality to prevent unauthorized access. The secure payment terminal may be placed at a facility, such as a user's home, and may remain communicatively coupled to a network, such as the Internet.

The GCE may include a processor, memory, and a network interface. The GCE may also include a display and an input interface (such as a keypad). In some implementations, the display and input interface may be implemented as a touchscreen. Other implementations are also possible.

The SCE may include a dedicated processor, one or more secure encrypted memory devices, one or more input devices, one or more output devices, and antitamper detection devices or countermeasures. In some implementations, the SCE of the device may interact with various components of the SCE and/or GCE of a payment terminal or other computing device to present information and to receive data. The secure encrypted memory may store a digital currency value, private keys, certificates (public keys of a device signed by a manufacturer), hash values, transaction data, other information, or any combination thereof.

In some implementations, a secure payment terminal may include, or may be coupled to, an interface enabling coupling of one or more devices to the secure payment terminal. For example, the secure payment terminal may include one or more device slots or openings, which may be sized to receive one or more devices. The secure payment terminal may establish a secure pairing with a portable computing device, such as a smartphone, and may couple to a device through one of the device slots. A user may interact with one of the touchscreen of the smartphone or the touchscreen of the secure payment terminal to initiate a download of blockchain asset data from a blockchain asset on the blockchain to the device, which may store the blockchain asset data as off-chain asset data in a secure memory.

The device may be a portable electronic device including the SCE with the secure memory to store the off-chain asset data, private keys, one or more certificates, transaction settlement models, salt data (i.e., random or pseudo random data that is used as an additional input to a one-way function, such as the exchange of public keys), other information, or any combination thereof. In some implementations, the device may be configured to establish secure communication between itself and another device through a payment terminal (a secure payment terminal including an SCE or a payment terminal that does not include an SCE, such as a point-of-sale (POS) payment terminal), which may or may not include an SCE. The secure communication refers to communication having end-to-end encryption where data is encrypted and decrypted only at the end points (devices) of the communications link. The secure communication allows for the exchange of encrypted data between the end points (between a first device and a second device) through one or more intervening devices, such as payment terminals, network switches, and so on. For example, a first device and a second device may exchange secrets, and subsequently the first device may send an encrypted message to the second device through a network. The data is encrypted and decrypted at the first device and the second device, but remains encrypted as it traverses the network, providing secure communications.

Further, the first device may provide validating information to the second device through the secure communication. The first device may also receive validating information from the second device through the secure communication. For example, the validating information may include a certificate consisting of a public key belonging to the SCE signed by a manufacturer or trusted party or other indicia of authenticity. This certificate may be used by the first device to authenticate the second device to establish a trust relationship. This trust relationship is used to establish trust of the transacting device as well as the mutual enforcement of consensus rules off-chain.

Then, the first device may receive a payment transaction from the second device that attempts to convey to the second device a portion of off-chain asset data stored on the second device. The portion may be less than or equal to the off-chain asset data. The payment transaction may include payment information and other information that may be used by the first device to determine the payment transaction is valid. The first device may be configured to determine a settlement model from a plurality of settlement models and to process the payment transaction based on the determined settlement model to validate and complete the payment transaction off-chain. For example, the selected settlement model may specify rules and other information that may be used by the first device, in conjunction with the payment transaction, to verify the off-chain asset data without committing the off-chain asset data to the blockchain. The first device may use the selected settlement model to determine the payment transaction is valid and to complete the transaction. The first device may then adjust a value of the off-chain asset data in the memory of the first device based on payment information within the payment transaction.

Additionally, the device may be used to perform multiple payment transactions (sending one or more payments, receiving one or more payments, or any combination thereof) with one or more other devices. Each payment transaction may be evaluated according to a settlement model to determine the payment transaction is valid. Subsequently, the device may be coupled to a secure payment terminal, which may be used to send a signed message to one or more of the blockchain servers to commit a portion of the off-chain asset data to the blockchain. The portion may be less than or equal to the off-chain asset data. For example, a user may elect to commit half of the off-chain asset data to the blockchain, leaving the other half available for payment transactions in the off-chain asset data. The portion may include any subset of the off-chain asset data or the entirety of the off-chain asset data. Other implementations are also possible.

It should be appreciated that the device, or a computing device with a mobile wallet, may be used to determine the payment transactions are valid based on off-chain asset data, and subsequently may be used to commit a portion of off-chain asset data to the blockchain. In person, or over a network, the device or the computing device with mobile wallet may be used to complete payment transactions using a selected settlement model of a plurality of settlement models without committing the off-chain asset data to the blockchain. By managing the transactions off-chain, the devices or the computing devices with the mobile wallet may avoid intermediate transaction costs by aggregating transactions in the off-chain asset data before committing the off-chain asset data (or a portion thereof) to the blockchain.

For example, the device may leverage physical functions to move blockchain asset data from a blockchain asset in the blockchain to a memory of a device, such as by coupling the device to a secure payment terminal. The secure payment terminal may receive the blockchain asset data from the blockchain and may provide the blockchain asset data to the device, which may store the blockchain asset data as off-chain asset data in its secure memory. The device may then be used to conduct payment transactions based on the off-chain asset data using one or more settlement models. The settlement models may define rules and processes used by the device to enforce blockchain rules while moving off-chain asset data, allowing for one or more payment transactions to be performed off-chain (without committing the off-chain asset data of each of the payment transactions to the blockchain). The off-chain asset data in the memory of the device may be updated based on the payment transactions. Subsequently, the device may commit at least a portion of the off-chain asset data to the blockchain by sending a signed message to one or more blockchain servers.

When a first device communicates with a second device through a network, the first and second devices may perform a Diffie-Helman key exchange to establish a secure communications link. Alternate methods of forming secure cryptographic channels may also be used. Once the secure communications link is established, the first device may encrypt and send its certificate (the public key of the device signed by the manufacturer) to the second device, and the second device may check one or more lists for trusted manufactures' public keys and verify the authenticity of the first device's manufacturer. Both devices have public keys, and they may each verify that the other's public key was signed by the device's manufacturer followed by a challenge response to verify possession of the corresponding private key to establish a trust relationship before proceeding with a digital currency transaction.

Each device may have unique key. For example, a manufacturer of the device may assign a globally unique code or another identifier to each device. Alternatively, the unique identifier may be calculated (automatically) as a hash value based on hardware circuit identifiers, a date and time stamp, a data storage date and time, a private key, other information, or any combination thereof. The unique identifier may be stored in a secure memory of the device. In some implementations, the unique identifier may be stored in a write-once read many (WORM) memory device that may be part of the secure memory.

In some implementations, the key may take the form of a physically stored secret, such as a physically unclonable function (PUF). At the time of manufacture, the manufacturer of the device may issue a unique cryptographically signed certificate for the device. A certificate may be made by signing a public key derived from the PUF of the device using the manufacturer's private key. The PUF dramatically enhances the overall security of the proposed system as it prevents the physical cloning of a device. If a device may be cloned, the typical consensus rule of not allowing “double-spends” cannot be reasonably enforced.

In some implementations, the device may include a memory, which may store firmware, which is cryptographically signed by the manufacturer and verifiable by devices of counterparties. Further, the firmware may cause a processor of the device to enforce double spend rules (rules that prevent successful spending of digital currency more than once), which are common in blockchains. The enforcement of the double spend rules by the devices allows the users to move the trust of settlement from the consensus mechanism of the blockchain to the hardware/firmware loaded on the devices. Once there is a high degree of confidence that the devices will enforce blockchain transaction rules, different forms of off-chain asset data may be passed from device to device, atomically, without committing the transaction to the blockchain and without requiring commonly used consensus protocols performed by the blockchain. For example, users will be able to download blockchain asset data corresponding to a blockchain asset in the blockchain, store the blockchain asset data as off-chain asset data in a memory of a device, perform one or more payment transactions (sending payment data, receiving a payment data, or both), and adjust a value of the off-chain asset data based on the one or more payment transactions without committing the off-chain asset data. The device may utilize a determined settlement model of a plurality of settlement models to determine validity of each of the one or more payment transactions and to complete each of the payment transactions determined to be valid. Subsequently, the user may utilize the device in conjunction with a secure payment terminal to commit the off-chain asset data (which have accumulated on the device, such as a smart card) to the blockchain. The off-chain asset data that are loaded onto the device may become bearer assets because the off-chain asset data cannot be backed up, and possession of the device that stores off-chain asset data will constitute possession (ownership) of the off-chain asset data. Duplication of the SCE would be prevented through the use of the PUF and the corresponding manufacturer certificate.

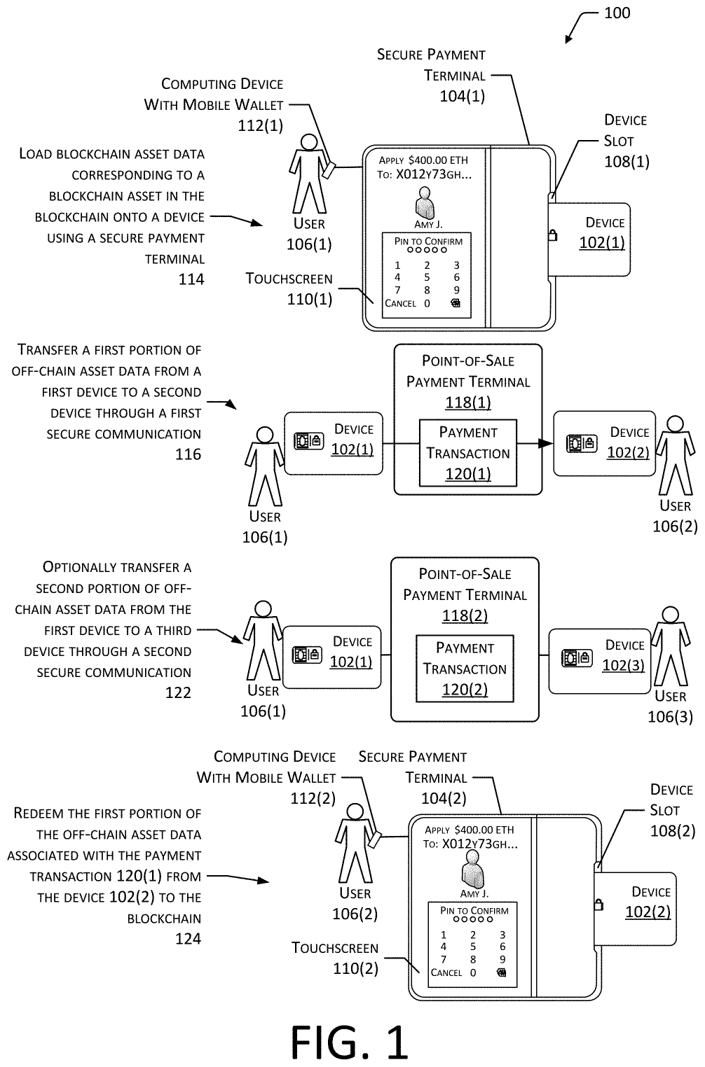

Further details of the settlement models are described below with respect to the various illustrative examples. One possible example of a system to enable payment transactions using off-chain asset data is described below with respect to FIG. 1.

FIG. 1 depicts a diagram 100 of a blockchain asset transaction using devices 102 to resolve digital currency transactions off-chain, according to one implementation. The system may include a device 102, which may be configured to interface with a secure payment terminal 104(1). The secure payment terminal 104(1) is deemed to be “secure” because it includes a secure computing environment (SCE). The device 102 may be communicatively coupled to the secure payment terminal 104(1). For example, a user 106(1) may insert a device 102(1) into a device slot 108(1) of the secure payment terminal 104(1), which may include a secure computing environment. The device slot 108(1) is depicted as a device slot sized to receive a device 102 that has a form factor similar to a credit card or electronic card. However, it should be understood that a device 102 may have other form factors, and that the device slot 108 may have a corresponding structure sized to receive the device 102. In some implementations, the device 102 may include electrical contacts to interface with the device slot 108. In other implementations, such as when the device 102 has a different form factor, the device 102 may include a wireless communication interface to provide wireless communication with the secure payment terminal 104, such as a near-field communication (NFC), or other short-range wireless communication.

The user 106(1) may interact with a touchscreen 110(1) of the secure payment terminal 104(1), with a touchscreen of a computing device 112(1) with a mobile wallet, or both to download blockchain asset data corresponding to a blockchain asset from a blockchain onto the device 102(1), as indicated at 114. The blockchain asset data may be stored in a memory of the device 102(1) as off-chain asset data. For example, the user 106(1) may interact with a mobile wallet application on the computing device 112(1) to initiate a download of blockchain asset data through the secure payment terminal 104(1) and onto the device 102(1).

Subsequently, the user 106(1) may remove the device 102(1) from the device slot 108(1). The user 106(1) may utilize the device 102(1) to send a payment transaction to another device 102(2) through a secure communication channel. For example, the device 102(1) may be coupled to a Point-of-Sale (POS) payment terminal 118(1), which does not include an SCE. The user 106(1) may interact with the POS payment terminal 118(1) to initiate a payment operation from the device 102(1) to a device 102(2). For example, the device 102(1) may utilize one or more communication interfaces of the POS payment terminal 118(1) to establish secure communication with a second device 102(2), by standard cryptographic methods. The devices 102 may also exchange additional information (such as certificates) to verify each other to establish a trust relationship. Once the secure communication and the trust relationship are established, the device 102(1) may send a payment transaction 120(1) to the device 102(2). The payment transaction 120(1) may include a portion of the off-chain asset data stored on the device 102(1).

As indicated at 116, a first portion of the off-chain asset data is transferred from a first (sending) device 102(1) to a second (receiving) device 102(2) through a first secure communication. For example, the first device 102(1) may send a signed, encrypted message including a payment transaction 120(1) to the second device 102(2). The second device 102(2) may utilize a selected one of a plurality of settlement models to resolve the payment transaction 120(1) without committing the payment transaction 120(1) to the blockchain. In other words, the device 102(1) may be used to perform an off-chain payment transaction with the device 102(2).

The device 102(1) adjusts a value of the off-chain asset data stored in its memory, while the device 102(2) adjusts a value the off-chain asset data stored in its memory based on the payment transaction 120(1). Prior to committing the value back to the blockchain, the user 106(1) may use the device 102(1) to complete another payment transaction 120, provided the remaining balance is sufficient to cover the amount. Similarly, the user 106(2) may use the device 102(2) to complete other payment transactions 120.

As indicated at 122, a second portion of the off-chain asset data may be transferred from the first device 102(1) to a third device 102(3) through a second secure communication. In this example, the user 106(1) may couple the device 102(1) to a second POS payment terminal 118(2) and may initiate a second payment transaction 120(2) to a third device 102(3). For example, the device 102(1) may utilize one or more communication interfaces of the POS payment terminal 118(2) to establish a second secure communication with a third device 102(3), by exchanging keys. The devices 102 may also exchange additional information (such as certificates, which may be public keys of the devices 102 signed by their respective manufacturers) to verify each other to establish a trust relationship. Once the secure communication and the trust relationship are established, the device 102(1) may send a payment transaction 120(2) to the device 102(3). The payment transaction 120(2) may include a second portion of the off-chain asset data stored on the device 102(1).

The third device 102(3) may use a selected one of a plurality of settlement models to determine the payment transaction 120(2) is valid and to complete the payment transaction 120(2) in response to determining the payment transaction 120(2) is valid. Further, the device 102(1) may adjust a value of the off-chain asset data stored in its memory based on the payment transaction 120(2), while the device 102(3) may adjust a value the off-chain asset data stored in its memory based on the payment transaction 120(2).

Subsequently, as indicated at 124, the first portion of the off-chain asset data associated with the payment transaction 120(1) may be redeemed from the device 102(2) to the blockchain. For example, the user 106(2) may insert the device 102(2) into a device slot 108(2) of a secure payment terminal 104(2). The user 106(2) may then use the computing device 112(2), the secure payment terminal 104(2), or both to generate a signed message to commit a portion of the off-chain asset data from the device 102(2) to the blockchain. The portion may include the first portion from the payment transaction 120(1) as well as other off-chain asset data. Alternatively, the portion may include off-chain asset data that is less than the first portion. Other implementations are also possible.

The devices 102 may be configured to manage secure communications between one another and to enforce blockchain rules to conduct payment transactions involving off-chain asset data without committing each of the payment transactions to the blockchain and without using conventional consensus protocols. The payment transaction may be conducted through secure communication over a network, but without committing the transaction to the blockchain (thus, it is “off-chain”). The devices 102 may be used to store off-chain asset data corresponding to a blockchain asset and to conduct payment transactions using the stored off-chain asset data.

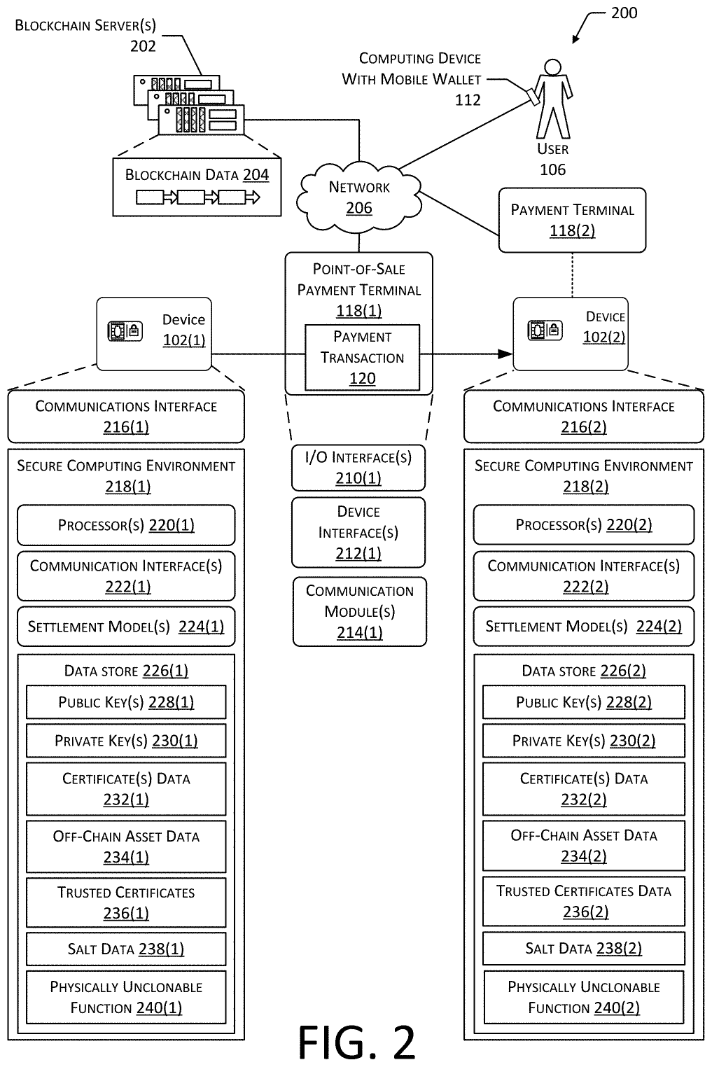

It should be appreciated that, though the device 102 is depicted as having a form factor similar to a credit card, the device 102 may be implemented in other shapes and sizes. For example, the form factor of the device 102 may be something other than a card shape. The device 102 may be implemented as a SIM card, as a wearable device, as a component (hardware, software, or both) within a smartphone or other computing device, and so on. One possible system is described below with respect to FIG. 2 in which devices 102 may be used to perform payment transactions 120 based on off-chain asset data without committing the payment transaction 120 to the blockchain.

FIG. 2 depicts a system 200 that utilizes a device 102 to conduct payment transactions 120 based on off-chain asset data through a POS payment terminal 118, according to one implementation. The system 200 may include one or more devices 102, each of which may store off-chain asset data 234. The off-chain asset data 234 may include data corresponding to different blockchain assets in the blockchain. In one possible example, the off-chain asset data 234 may include blockchain asset data 234 corresponding to one or more blockchain assets in the blockchain of a single currency type. In another possible example, the off-chain asset data 234 may include data corresponding to different cryptocurrencies. The device 102 may maintain the off-chain asset data 234 for each cryptocurrency in such a way that they are not comingled. Further, a payment transaction 120 that uses the off-chain asset data 234 may include a single cryptocurrency type.

A device 102(1) may communicate with a POS payment terminal 118(1) to establish a secure communication with another device 102(2). The POS payment terminal 118(1) may be configured to communicate with a network 206, which may include the Internet. Further, the POS payment terminal 118(1) may communicate with one or more other devices through the network 206, such as another POS payment terminal 118(2), one or more blockchain servers 202 storing blockchain data 204, a computing device 112 with a mobile wallet application, a secure payment terminal 104 (in FIG. 1), other devices, or any combination thereof. The one or more blockchain servers 202 may include distributed computing devices that cooperate to perform various blockchain operations, including mining digital assets and associated transactions as well as storing blockchain data 204.

In a conventional transaction, signed message data including cryptocurrency transaction details may be sent from the POS payment terminal 118 to the one or more blockchain servers 202. The blockchain servers 202 may then process the signed message data. If the signed message data is determined to be valid by one or more of the blockchain servers 202 (such as by a consensus model), one or more of the blockchain servers 202 may commit the transaction details from the message to the blockchain by incorporating the transaction details into the blockchain data 204.

It should be appreciated that, while the network 206 is shown as a single network element, the network 206 may include one or more networks 206 that may facilitate communication between devices 102. For example, the network 206 may include short-range wireless networks (such as Bluetooth communications links, local area networks (wired or wireless), Wi-Fi, and so on), wide-area networks (such as the Internet, WiMax, satellite, cellular, other networks, and so on), or any combination thereof. In some implementations, the POS payment terminal 118(1) (or the secure payment terminal 104) may facilitate communications between a first device 102(1) and a second device 102(2). In other implementations, the POS payment terminal 118(1) (or the secure payment terminal 104) may facilitate communications between a first device 102(1) and a second device 102(2) through another POS payment terminal 118(2). Further, in some implementations, the POS payment terminal 118(1) (or the secure payment terminal 104) may facilitate communications between the device 102(1) and the computing device 112 with the mobile wallet. Other implementations are also possible.

In this example, the POS payment terminal 118 may not include a secure computing environment (SCE). The POS payment terminal 118 may include one or more input output (I/O) interfaces 210. The I/O interfaces 210 may include a keypad, a display, a switch, one or more network transceivers, one or more ports or connectors to couple one or more external devices to the POS payment terminal 118, other interfaces, or any combination thereof. The one or more external devices may include a keyboard, a stylus, a trackpad, a mouse, a touchscreen, another input device or any combination thereof.

The POS payment terminal 118 may further include device interfaces 212. The one or more device interfaces 212 may include at least one device slot 108 or opening sized to receive the device 102(1), the device 102(2), or both. In some implementations, the one or more device interfaces 212 may be configured to receive, and optionally secure, at least a portion of the device 102. For example, the one or more device interfaces 212 may include a device slot 108 sized to receive and secure part of the device 102. The one or more device interfaces 212 may also communicate data to and receive data from the device 102.

The POS payment terminal 118 may also include one or more communication modules 214, which may control interactions between the I/O interfaces 210 and the device interfaces 212 to facilitate transfer of secure session data between devices 102 coupled to the device interfaces 212, between a device 102(1) and a device 102(2) coupled to another POS payment terminal 118(2), between a device 102 and a computing device 112, and so on.

The devices 102 may manage the secure communications and the transactions in such a way that the POS payment terminal 118 need not be a trusted terminal. This enables the device 102 to be used at a point of sale to complete a purchase transaction. For example, the devices 102 may be configured to negotiate secure communication such that all communications between the devices 102 are encrypted, providing end-to-end encryption where data is encrypted and decrypted only at the end points of the communications link (i.e., only at the devices 102). Other implementations are also possible.

The device 102 may include one or more communication interfaces 216 to communicate with the device interface 212 of the POS payment terminal 118. For example, the device 102(1) may include one or more communication interfaces 216(1) configured to communicatively couple to the device interface 212(1) of the POS payment terminal 118(1). In some implementations, the one or more communication interfaces 216(1) may communicate data to and receive data from the device interface 212(1).

The device 102 may further include a secure computing environment (SCE) 218, which may utilize a secure operating system (OS) and which may implement controls over transfer of data to and from a memory of the SCE 218. The SCE 218 may include one or more hardware processors 220, one or more communication interfaces 222, one or more settlement models 224, and a datastore 226. The processor 220(1) may utilize the communication interface 222(1) to establish a secure communication with another device (such as the device 102(2)) and to verify and authenticate data received from the other device. For example, the communication interfaces 222 may be used to exchange public keys 228 to establish secure communication.

The device 102 may include a data store 226, which may store one or more public keys 228, one or more private keys 230, one or more certificates data 232 consisting of the device's public key 228 signed by the manufacturer, off-chain asset data 234, trusted certificates data 236, and salt data 238. The trusted certificates 236 may include a list of one or more trusted manufacturer public keys. The salt data 238 may include random or pseudo random data that may be used in an encryption operation. In some implementations, the data store 226 may further include a physically unclonable function 240.

In some implementations the certificate data 232 may refer to a manufacturer of the assembled device 102. In other implementations the certificate data 232 may be the device's public key 228 signed by a manufacturer of the SCE 218, a manufacturer of one or more of the processors 220, a manufacturer of a secure memory including the data store 226, or the manufacturer of another component. In still another implementation, the certificate 232 may refer to the device's public key 228 signed by a software developer that implements the firmware or instructions stored in the SCE 218. Other implementations are also possible.

For example, the device 102(1) may send its public key 228(1) to the device 102(2) via the communication interface 222 via the device interface 212 and optionally the I/O interfaces 210, the network 206, and the POS payment terminal 118(2). The device 102(2) may encrypt its public key 228(2) and salt data 238(2) using the public key 228(1) to form encrypted data and may send the encrypted data to the device 102(1). The device 102(1) may receive and decrypt the encrypted data to recover the public key 228(2) and the salt data 238(2). The device 102(1) may then encrypt the salt data 238(2) using the public key 228(2) to form encrypted data and may send the encrypted data to the device 102(2), which may decrypt the encrypted data and verify the salt data 238(2). If the salt data 238(2) is verified, the secure communication is established, and subsequent communications between the device 102(1) and the device 102(2) are encrypted before transmission.

The devices 102 may exchange further information, such as the certificate data 232 or other indicia of authenticity to establish a trust relationship. For example, the device 102(1) may send encrypted data including information about its manufacturer and the certificate data 232(1) to the device 102(2). The device 102(2) may validate the certificate data 232(1) and may acknowledge to the device 102(1) that it was verified. For example, the device 102(2) may search a local list of trusted manufacturers (trusted certificates data 236(2)), which may be stored in the data store 226(2) and with which a trust relationship may be established. For example, if the manufacturer or data related to the manufacturer is included in the trusted certificates data 236(2), the device 102(2) may verify the certificate 232(1) of the device 102(1).

The device 102(2) may send encrypted data including information about its manufacturer and a certificate 232(2) to the device 102(1). The device 102(1) may determine the certificate data 232(2) is authentic based on the list of trusted certificates data 236(1) and may acknowledge to the device 102(2) that it was verified. After this verification, the trust relationship has been established.

Once the devices 102(1) and 102(2) have established secure communication and have verified one another using their certificates 232, the device 102(1) (sending device) may send encrypted data including a payment transaction 120 to the device 102(2) (receiving device). The device 102(2) may determine a settlement model 224 of the plurality of settlement models 224(2) to verify and complete the payment transaction 120.

An alternate form of verification may take place using a challenge response mechanism. The first device 102(1) may provide challenge data to a second device 102(2). The second device 102(2) may then generate a response to the challenge data. Only genuine devices should be able to produce such a response. The second device 102(2) may then provide the response to the first device 102(1). Using one or more challenge response rounds, the first device 102(1) may ascertain the provenance of the second device 102(2) and deem the second device 102(2) to be trustable.

The payment transaction 120 may include appropriate information for the receiving device 102(2) to verify the off-chain asset data being used for settlement based on the selected settlement model 224(2). In some implementations, the device 102(1) may request salt data 238(2) from the device 102(2). The salt data 238(2) may include random or pseudo random data that is used as an additional input to a one-way function, such as the payment transaction 120. In response, the device 102(2) may provide encrypted data including a portion of the salt data 238(2) to the device 102(1) for use in the transaction. The device 102(2) may also record the portion in a valid salt list stored in the salt data 238(2).

The device 102(1) may generate encrypted data including the payment transaction 120, including appropriate information to allow the device 102(2) to verify the payment transaction 120, and the portion of the salt data 238(2). The device 102(1) may send the encrypted data to the device 102(2). Additionally, the device 102(1) may adjust a value of the off-chain asset data 234(1) from the data store 226(1) based on payment information in the encrypted data. In response to receiving the encrypted data, the device 102(2) may verify the salt, validate the payment transaction 120 (determine the payment transaction 120 is valid) using the selected settlement model 224(2) based on the appropriate information and the settlement model 224(2), and adjust a value of the off-chain asset data 234(2) based on the payment transaction 120. Further, the device 102(2) may delete the portion of the salt data 238(2) from the list of salt data. The use of salt prevents a transaction from being replayed multiple times to the device 102(2) using an external device.

The one or more settlement models 224 may include various sets of rules and processes that may be implemented to validate payment transactions 120 without committing the off-chain asset data 234 to the blockchain and without requiring commonly used consensus protocols. For example, the settlement models 224 may be applied by the devices 102 to enforce blockchain rules while allowing validation and completion of payment transactions 120. The settlement models 224 may be used, off-chain (in other words, without committing the transaction to the blockchain), by the device 102 to enable payment transactions 120. The settlement models 224 may include, but are not limited to, a key (first) settlement model, a bill (second) settlement model, an account (third) settlement model, an authority (fourth) settlement model, a stochastic (fifth) settlement model, or any combination thereof.

With respect to the key settlement model of the settlement models 224, the devices 102(1) and 102(2) may exchange a private key 230 that corresponds to a digital asset in the blockchain, such that the private key 230 may be accepted as payment. It should be understood that scarce tradable assets (sometimes referred to as tokens or cryptocurrencies, i.e. blockchain assets) exist on the blockchain data 204. The ability to move a blockchain asset from one account to another denotes the ability of a user 106 (an owner of the blockchain asset) to spend funds, and therefore equates to possession of those funds. Typically, a blockchain asset transaction may be initiated by signing a message using a private key 230, and the signed message indicates the movement of funds from one account to another account based on the private key 230 of the originating account. If the originating account has sufficient funds and the signature of the signed message is verified, the one or more blockchain servers 202 will process the transaction and funds will be transferred on the blockchain data 204 from the originating account to the receiving account. Such a blockchain transaction commits the digital currency data to the blockchain.

Within the key settlement model, the private key 230 that is used to sign a blockchain transaction and that is used to sign a message to commit a blockchain transaction to the blockchain may be used to represent the digital asset on the blockchain. Using the key settlement model, the device 102(1) may pass an individual private key 230 to another device, such as the device 102(2). The device 102(2) may accept the private key 230 as payment by using the key settlement model from the settlement models 224 to check a blockchain asset on the blockchain data 204 that corresponds to the private key 230. Based on the selected key settlement model of the settlement models 224(2), the device 102(2) may trust that the device 102(1) will permanently delete the private key 230 that is passed and that no other copy of that private key 230 exists. The private key 230 itself thus may become the bearer asset. Since the private key 230 is not divisible, only the whole value represented by that private key 230 in the blockchain may be transacted between the device 102(1) and the device 102(2).

Alternatively, the device 102(1) may elect to subdivide the assets associated with a single private key 230 in more than one transaction with more than one party. This may be done by sharing the private key 230 as well as the value to which the recipient device 102(2) is entitled. The disadvantage of sharing private keys is that the private key 230 is stored in multiple places and, if any copy is compromised, all transactions descending from that private key 230 would be compromised. Additionally, if more than one device attempted to redeem an asset back to the blockchain within the same block using the same UTXO, only one of the transactions would be recorded to the blockchain. This is problematic in that both devices would have decremented the asset balance and would not be able to sign a new redemption transaction. One potential solution would be to allow devices to reset a balance if an appropriate proof was provided showing an alternate transaction was mined into the blockchain with an arbitrary amount of subsequent work.

It should be understood that, to verify the asset in the blockchain, the device 102(2) may query the blockchain server 202 through the network 206 to locate the blockchain asset that corresponds to the private key 230. This verification may be performed using data provided to the device 102(2), such as a transaction ID, a public key hash, or a script hash prior to providing the private key. For example, the device 102(2) may send a query including data related to the private key 230 to the one or more blockchain servers 202. The device 102(2) may receive a response including an address of the blockchain asset within the blockchain and optionally other information (such as an asset type, an asset value, a MD160 hash (which is sometimes referred to as a RIPEMD-160 hash, where RIPEMD stands for Research and Development in Advanced Communications technologies in Europe (RACE) Integrity Primatives Evaluation Message Digest (RIPEMD) with a 160-bit encryption hash developed by Hans Dobbertin, Antoon Bosselaers, and Bart Preneel at the COSIC research group at the Katholieke Universiteit Leuven in Leuven, Belgium), a script hash, a transaction ID, a block number, a current block difficulty, a total block difficulty, one or more blockchain headers, hashes which allow mapping of the correspondent transaction to a block header, other data, or any combination thereof). If the private key 230 is found to be associated with a blockchain asset within the blockchain, the device 102(2) may receive an indication from the one or more blockchain servers 202 and may choose to accept or reject the payment transaction 120 based on characteristics of the associated asset in the blockchain. According to the key settlement model, if the blockchain asset associated with the private key 230 is present in the blockchain and has a value that corresponds to an amount due in the payment transaction 120, the device 102(2) may accept the private key 230 as payment and may store the private key 230 as off-chain asset data 234(2). Since a redemption transaction on the blockchain data 204 will always cost a finite amount, this key-based transaction may limit the viable lower bound transaction value that may be transacted by passing keys.

Another settlement model 224 may be referred to as an unspent transaction output (UTXO) settlement model. In the UTXO model, the device 102(1) may encumber a blockchain asset by creating a UTXO, which encumbers funds by a hash lock. In some implementations, the UTXO may represent an input to a new transaction that results from unspent output of a previous transaction. The UTXO may be created on the device 102(1) without interacting with the blockchain. The device 102(2) may then receive the UTXO as well as associated data (such as a pre-hash image, which may represent an input to a hash function used in connection with the generation of the UTXO), and which may be used, at a later time by the device 102(2) to un-encumber the funds locked by the UTXO. In an example, the redemption of the UTXO may be accomplished by providing a signed message to the one or more blockchain servers 202. The recipient device 102(2) may validate that the paying device 102(1) created the UTXO from an account that has sufficient funds to cover the payment using the UTXO settlement model. When the value of the UTXO is redeemed using the device 102(2), the device 102(2) may be coupled to a secure payment terminal 104 and may first broadcast the UTXO to the one or more blockchain servers 202 and then create a transaction redeeming that UTXO to an account by presenting the account information and the associated data.

In the UTXO settlement model, the user 106 may use the device 102 to spend the UTXO (or a portion thereof) as off-chain asset data prior to redeeming the UTXO to the blockchain data 204, the UTXO may be presented as a bearer asset to another device 102, without interacting with the blockchain. The receiving device 102 may verify that the UTXO is redeemable on-chain (meaning that the UTXO has not yet been spent and redeemed to the blockchain) and may accept the payment transaction 120 that includes the UTXO based on the UTXO settlement model. In the context of devices 102, the UTXOs may be thought of as analogous to a paper bill. It should be understood that, when the UTXO funds are redeemed, the original source address of the UTXO funds will be known from the associated data (such as the preimage hash), but intermediary fund holders will not be known and will not be included on the blockchain data 204.

In some implementations, the associated data may include a preimage hash. The preimage hash refers to an initial value that may be provided to a hash function to achieve a desired output value. The hash function may be difficult to invert, making it difficult for an attacker to determine a preimage hash for any given output value, given that the attacker has no a-priori knowledge of the hash function. Thus, the preimage hash may be used as a key to unlock the UTXO.

The UTXO will typically have a non-trivial value, and each UTXO may be redeemed in an individually processed and verified transaction when redeeming the UTXO to the blockchain data 204. One possible advantage of UTXO-based asset trading is that a device 102 may generate UTXOs as needed and when needed. Also, a receiving device 102 that receives a UTXO may verify that the UTXO is redeemable by making a simple read query to the blockchain data 204 without committing the UTXO to the blockchain.

If the device 102 is hacked, lost, or compromised, the potential loss is localized to the value of the UTXO(s) on that device. Additionally, if a non-trivial fee is assessed when redeeming the UTXO to the blockchain data 204, each UTXO will have a non-trivial value, which sets a lower limit on the value of a UTXO which will be practical. For example, if a current processing fee for a payment transaction is $0.05 and the off-chain asset data 234 (i.e., UTXO in this example) is worth one dollar, redeeming the payment transaction may make sense for some users 106. However, if the off-chain asset data 234 (UTXO in this example) was worth $0.10 and the transaction fee is $0.05, the transaction fee becomes a significant portion of the UTXO value, making the UTXO transaction using the off-chain asset data 234 less practical.

Still another model of the settlement models 224 is an account settlement model in which a device 102 may be loaded with off-chain asset data from a blockchain asset via a transaction on the blockchain data 204. The device 102 may thus be loaded with an initial balance corresponding to a public address (with the private key 230 derived from or encrypted by a physically unclonable function (PUF) 240) in the blockchain data 204. The device 102(2) may verify a payment transaction 120 from the device 102(1) based on a copy of the loading transaction including the transaction ID and associated data. The device 102(1) or 102(2) will then know that it has a certain amount of an asset that came from a specific transaction ID. It is very difficult to verify what that specific asset is because of the nature of blockchain data 204. For example, Bitcoin is defined as the blockchain that has the most work on top of the genesis block created by Satoshi Nakomoto in 2009. However, there have been many forks in the bitcoin blockchain, and there are different assets that look very similar, such as Bitcoin Cash. Unless a user 106 may holistically verify the asset, he or she may be duped into what is considered the canonical Bitcoin. Therefore, instead of attempting to create a proof of what the asset is, the transaction ID may be passed to the receiving device 102(2), and the device 102(2) may use an account settlement model to verify that the transaction ID that funded the balance on the paying (sending) device 102(1) is indeed present in the blockchain data 204. Once the presence of the transaction ID on the blockchain is verified by the receiving device 102(2) using the account settlement model, the device 102(2) may accept the payment transaction 120 from the device 102(2) and adjust a value of the off-chain asset data 234(2)) stored in the data store 226(2) of the SCE 218(2). Further, the device 102(1) may adjust a value of the off-chain asset data 234(1) by the amount specified in the payment transactions 120. Subsequently, to redeem the off-chain asset data 234(2) (or a portion of the off-chain asset data 234(2)) back to the blockchain data 204, the device 102(2) may sign a transaction with its private key 230(2), where the transaction includes a portion of off-chain asset data 234(2) and a public key 228(2), such as the certificate data 232(2) showing the validity of the device 102(2), and a signed request to redeem an amount to an alternate on-chain account or to an account on the device 102(2) by sending the signed message to the one or more blockchain servers 202. Redemption of an off-chain asset to an on-chain asset allows the device 102 to potentially hold less data and removes any risk to the user's funds that the off-chain system may be compromised and their assets stolen.

Using the account settlement model, the device 102(2) may query the blockchain to find the transaction ID from the payment transaction 120 in the blockchain. Once found, the device 102(2) may verify that the payment information in the payment transaction 120 is less than the blockchain asset corresponding to the transaction ID. When the transaction ID is located in the blockchain and the blockchain asset associated with the transaction ID is greater than the payment amount in the payment transaction 120, the device 102(2) may accept the payment transaction 120 and update the off-chain asset data 234(2). For example, the device 102(2) may send a query including the transaction ID to the one or more blockchain servers 202. The device 102(2) may receive a response including an address of a blockchain asset within the blockchain that corresponds to the transaction ID and optionally other information (such as an asset type, an asset value, other data, or any combination thereof) if the one or more blockchain servers 202 locate the blockchain asset associated with the transaction ID in the blockchain. If the transaction ID is not located within the blockchain, the device 102(2) may receive an indication from the one or more blockchain servers 202 and may reject the payment transaction 120.

The account settlement model enables amounts that correspond to a single asset type in the blockchain data 204 to be aggregated together when they are redeemed in a single redemption transaction, reducing the transaction costs associated with the redemption process. The account settlement model allows off-chain asset data to be treated as an account balance rather than a specific asset. Thus, the account settlement model may handle off-chain asset data like change (such as quarters, dimes, nickels, pennies, and so on) rather than bills (such as one-dollar bills, five-dollar bills, and so on) as in the key or UTXO settlement model.

Losses due to a hack or theft may be higher because such a theft or loss may affect more than one specific payment transaction 120. Although transaction balances may be added, each contributing transaction ID may be checked to validate the redemption of the off-chain asset data, which may make committing the off-chain asset data to the blockchain more expensive that with others of the settlement models 224. Additionally, in some implementations, the device 102 may have limited storage space so the device 102 may only be able to hold a finite number of transaction IDs before the off-chain asset data must be committed to the blockchain.

In some implementations, the lack of fungibility of multiple transaction IDs may be ameliorated by having economically incentivized change makers, such as the manufacturer of the device 102 or a third-party trusted authority. The change makers may transfer blockchain asset data from a blockchain asset to a smart contract. Subsequently, a user 106 may utilize a device 102 to request change from the smart contract. If the terms of the smart contract are met, the smart contract may provide the change to the device 102, which may update the off-chain asset data 234 based on the change. These change makers may elect to charge a fee for making change. The benefit to the users 106 is that more of the change may come from a small number of transaction IDs, making the change less expensive to redeem, as compared to an account settlement model, where the transaction ID is verified as part of the redemption operation.

Yet another settlement model 224 may include an authority settlement model in which the loading transaction may be signed by an issuing authority, such as the manufacturer of a device 102 or another authority, or may be made from a specific account. This issuing or loading authority signature would provide off-chain asset data 234 to a device 102 together with an indication of authenticity (such as a certificate or proof of the authenticity of the loading authority). The loading authority may be a corporate entity that loads off-chain asset data 234 onto devices 102 as a service. For example, a banking institution may offer “loading authority” services in which the banking institution loads the off-chain asset data 234 onto the device 102.

Upon receiving a payment transaction 120 at the device 102, the device 102 would determine a payment transaction 120 is valid based on the trustworthiness of the loading authority. This means that the counterparty devices (such as the device 102(2)) would not need to verify the existence of a UTXO or transaction ID. Instead, when the device 102(1) is loaded, the device 102(1) knows that the balance comes from the blockchain asset that the loading authority attests to. When a counterparty is taking payment via the device 102(2), the counterparty may request payment in off-chain asset data that has been loaded by a trusted loading authority. The device 102(2) may verify that the sending device 102(1) satisfies the trusted loading authority request by inspecting the signed certificate issued with the off-chain asset data 234(1). In some implementations, the receiving device 102(2) may be configured to accept attestations by multiple authorities by adding the public key 228(2) of those authorities to the device 102(2). If an authority becomes nefarious, the user 106 may remove the key of that authority from the device 102(2) for future transactions, creating an incentive for loading authorities to do a “good” job because a single infraction or misuse of the loading authority's private key 228 may decimate an authority's business. In this implementation, the device 102(1) would present, to the device 102(2), the signature from the loading authority that was used to initialize the off-chain asset data 234(1) to prove the appropriate asset type. When a user 106 wants to redeem the off-chain asset data 234 to the blockchain data 204, the user 106 may use the device 102(2) to present the loading authority's signature to the blockchain, a valid device certificate, as well as a signed request to move funds corresponding to the certificate. Unlike, the settlement model 224 that uses transaction IDs to determine asset types, there may be fewer prevalent loading authorities so the number of transaction IDs that need to be verified may be limited to the number of authorities used, which may be as low as one, even with thousands of transactions and thousands of counterparties.

Another of the settlement models 224 may include a proof of stochastic settlement model. This approach may use a proof as well as a set of rules or models that are descriptive of specific off-chain asset data such that a device 102 may verify the off-chain asset data against a model without having to make an on-chain read of data. The stochastic settlement model may be used to validate an off-chain transaction, even if the device 102 cannot access the Internet. For example, a payment transaction 120 may include payment information and an associated proof. The proof may include data that may represent the blockchain at the time that the blockchain asset data was downloaded. In one example, in an uncompressed form, the proof may be an uncompressed copy of the entire blockchain. If a proof is made in a completely uncompressed way, the proof of the transaction would include an up-to-date copy of the underlying blockchain data 204. In a practical example, the proof may be a compressed representation of the blockchain, such that the blockchain is represented by a set of hashes that demonstrate that the blockchain asset was included in a data block in the blockchain. For example, proofs may be made using interlinking hashes, which allow the compression of the blockchain. In some implementations, a function may convert data of a block of the blockchain into an encrypted output of a fixed length called a hash. Applied to multiple blocks of the blockchain, the function converts the data of the multiple blocks that are interlinked by the internal references contained within the blocks. The resulting “interlinking hashes” may be a compressed representation of the blockchain. The stochastic settlement model describes characteristics of the blockchain data 204 in concise form, which may include a rate of work performed on the blockchain, a block time, a number of transactions per block, as well as historic checkpoints. Based on the characteristics of the transaction and associated proof, the underlying blockchain asset for the payment transaction 120 may be ascertained with a high degree of confidence by comparing the proof to the blockchain model. For example, the device 102(1) may have a list of acceptable proofs that may be used to ascertain funding transactions underlying an asset. During resolution of a payment transaction 120, the device 102(1) may provide information about the transaction that was used to verify the proof, and the device 102(2) may decide to accept the payment transaction 120 or not based on the confidence that the proof provided meets the requirements for device's 102(2) corresponding blockchain model. In the context of a single smart contract which gateways the funding transactions for all devices 102, only blockchain models that are acceptable to the smart contract would be acceptable by another device 102. The blockchain models that are acceptable to the smart contract may be deployed in the smart contract and may also be signed by the issuing entity of the device 102.

The device 102 enables off-chain digital currency transactions, enhancing the portability of digital currencies (i.e., cryptocurrencies). Moreover, the settlement models 224 are used by the device 102 to resolve payment transactions 120 and to enforce blockchain rules within the device 102. Since the device 102 enforces the blockchain rules, off-chain asset data 234 stored in the device 102 may be relied upon to perform off-chain payment transactions 120 and to aggregate payment transactions 120. Subsequently, the off-chain asset data (or a portion thereof) may be committed to the blockchain.

Further, since the device 102 manages its own secure communications, the POS payment terminal 118 need not be secure. Thus, the device 102 may be used at point of sale facilities, with reduced concern for theft. The device 102 provides significant advantages over conventional cryptocurrency systems, because the device 102 makes the blockchain asset more accessible and more portable, while establishing mechanisms for enhancing security when the device 102 is used off-chain or in connection with other devices that do not have an SCE (such as a POS payment terminal 118). Other advantages will also be apparent to those of ordinary skill in the art upon review of the present disclosure.

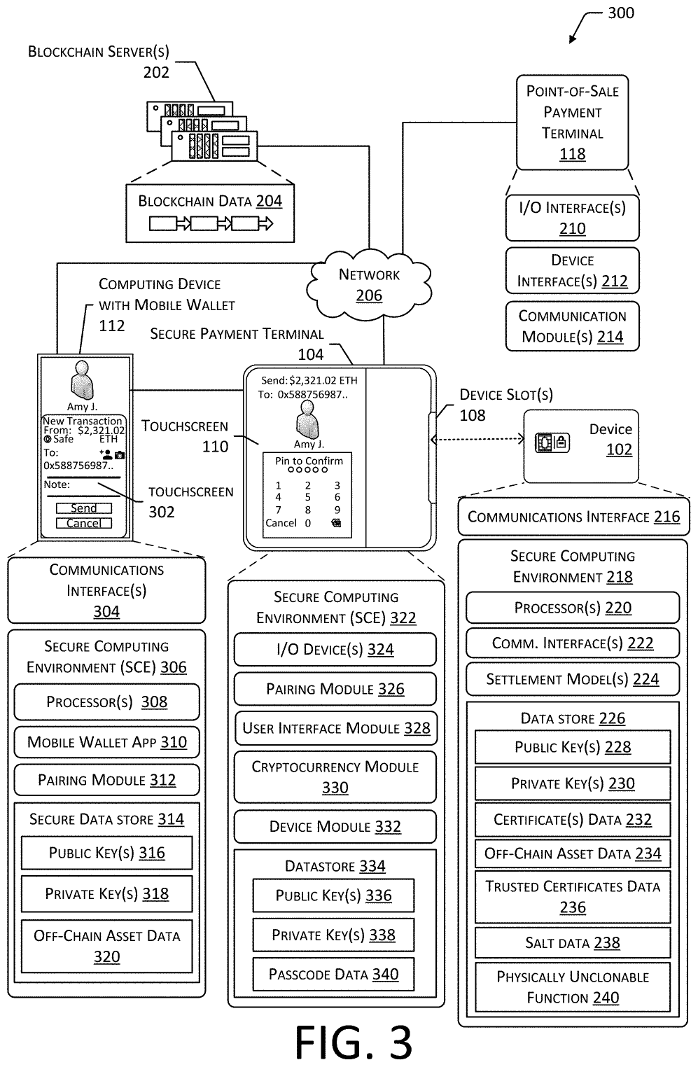

It should be appreciated that the settlement models 224 that are described above are illustrative only, and are not intended to be limiting. Other settlement models 224 may also be used to resolve payment transactions 120 (cryptocurrency transactions) off-chain. Further, while the above-described settlement models 224 have been referenced with respect to transactions between devices 102, it may also be possible to use the same models to resolve transactions between a device 102 and a computing device 112, or between the device 102 and a secure payment terminal 104, such as that described below with respect to FIG. 3. Additionally, while the settlement models 224 are depicted as being included in the device 102, it should be appreciated that the settlement models 224 may be included in other devices, such smartphones, laptop computers, and so on.

FIG. 3 depicts a system 300 including a secure payment terminal 104 to facilitate downloading of blockchain asset data to one or more devices 102 that store off-chain asset data 234, according to one implementation. The secure payment terminal 104 may include a touchscreen 110 or another input interface to receive user inputs. Further, the secure payment terminal 104 may include one or more device slots 108 to receive one or more devices 102. Further, the secure payment terminal 104 may include an internal device of a different form factor which is functionally similar to a device 102. The secure payment terminal 104 may be configured to communicate with the network 206. Further, the secure payment terminal 104 may communicate with a POS payment terminal 118, one or more blockchain servers 202, one or more computing devices 112 with mobile wallets, or any combination thereof through the network 206. In some implementations, the secure payment terminal 104 may communicate with the computing device 112 through a paired communication link, which may be a wired connection or a short-range wireless communications link, such as Bluetooth, Bluetooth Low Energy, ZigBee, and the like. The device 102, the POS payment terminal 118, and the one or more blockchain servers 202 may include the same components as described above with respect to FIGS. 1 and 2. In this implementation, the computing device 112 may be implemented as a portable computing device, such as a smartphone, laptop, or tablet computing device.

The computing device 112 may include a touchscreen 302 configured to present images, text, and user-selectable elements, such as pull-down menus, tabs, clickable links, soft buttons, radio buttons, check boxes, text fields, other options, or any combination thereof. For example, the touchscreen 302 may present web pages, application interfaces, a soft-key pad, other data, other user-selectable options, or any combination thereof.

Further, the computing device 112 may include one or more communication interfaces 304 that may include one or more transceivers, radios, and other components to send data to and receive data from the secure payment terminal 104. The communication interfaces 304 may also control radio frequency communications between the computing device 112 and the network 206, which, in addition to the Internet, may include a communications network, such as a cellular network, satellite network, digital communications network, other networks, or any combination thereof.

The computing device 112 may also include a secure computing environment (SCE) 306, which may be implemented using software, dedicated SCE circuitry, or any combination thereof. The SCE 306 may further include one or more hardware processors 308 and a mobile wallet application 310 that may be executed by the processors 308 to interface with one or more of the blockchain servers 202 or with the secure payment terminal 104 to download blockchain asset data corresponding to a blockchain asset in the blockchain and to store the downloaded data as off-chain asset data 320 in a secure data store 314 within the computing device 112. In some implementations, the mobile wallet application 310 may allow a user 106 of the computing device 112 to download or transfer off-chain asset data to the device 102, such as by sending the digital currency asset to a unique address or identifier associated with the device 102, which digital currency asset may be received by the device 102 through a payment terminal, such as the secure payment terminal 104 or a POS payment terminal 118. In this example, the secure payment terminal 104 may provide the off-chain asset data 234 to the device 102 for storage in the data store 226 of the secure computing environment 218.

In some implementations, a user 106 of the computing device 112 may utilize the mobile wallet application 310 to request signatures from the secure payment terminal 104 and to broadcast results as transactions. In some implementations, a user 106 of the computing device 112 may utilize the mobile wallet application 310 to interact with the secure payment terminal 104 to load off-chain asset data 234 onto the device 102.

The SCE 306 may also include a pairing module 312, which may control the communication interface 304 to negotiate and establish a secure pairing with the secure payment terminal 104. For example, the pairing module 312 may utilize Bluetooth protocols or other short-range (or long range) wireless protocols to establish secure communication with the secure payment terminal 104.

The SCE 306 may further include the secure data store 314, which may include public keys 316, private keys 318, and optionally off-chain asset data 320, which may have been downloaded from the blockchain data 204 or which may have been received through a completed payment transaction 120. In some implementations, the public keys 316 may be provided by a physically unclonable function (PUF). Other implementations are also possible.

The secure payment terminal 104 may provide a hardware and software solution that enables a non-technical person to safely and easily participate in cryptocurrency transactions. The secure payment terminal 104 may duplicate services provided by a bank by allowing a user 106 to transfer blockchain asset data to a mobile wallet application 310 of a computing device 112 for storage in the secure data store 314 as off-chain asset data 320. Alternatively, the secure payment terminal 104 may allow a user 106 to transfer blockchain asset data to the device 102, which may resemble a credit card, for storage in the data store 226 as off-chain asset data 234.

The secure payment terminal 104 may include a secure computing environment (SCE) 322. In one possible non-limiting implementation, the SCE 322 may comprise the Kinetis K81 microcontroller unit (MCU) from NXP Semiconductors N.V. of Eindhoven, the Netherlands. In other implementations, the SCE 322 may comprise other devices. In some implementations, the SCE 322 may comprise hardware and processor-executable instructions that cooperate to encrypt data stored within the SCE and to restrict access to the data.

The SCE 322 may include one or more input output (I/O) devices 324. The I/O devices 324 may include components for communicating data to and receiving data from a device 102, one or more transceivers for communicating data to and receiving data from the computing device 112, and so on. Further, the I/O devices 324 may include an interface associated with the touchscreen 110 to provide data (text, images, user-selectable options, or any combination thereof) to the display portion of the touchscreen 110 and a touch-sensitive interface associated with the touchscreen 110 to detect inputs.

The SCE 322 may further include a pairing module 326, which may communicate with the pairing module 312 of the computing device 112 to establish secure communication. For example, the pairing module 326 may implement a Bluetooth pairing operation between the secure payment terminal 104 and the computing device 112. The pairing module 326 may generate or update pairing data, which may be stored in a datastore 334 within the SCE 322. Pairing indicates an established relationship and associated secure communication between the secure payment terminal 104 and the computing device 112. The pairing module 326 may be configured to participate in and control the pairing process. For example, the secure payment terminal 104 may receive message data associated with pairing, such as a source identifier, a source address, a public key 316, and so forth. The secure payment terminal 104 may process the message data using the pairing module 326.

The pairing module 326 may use a user interface module 328 to present a graphical interface via the I/O devices 324 in the SCE 322 to the touchscreen 110. For example, the graphical interface may include a prompt (text and one or more selectable options) on the touchscreen 110 asking for an input to approve the pairing. The graphical interface may include a plurality of selectable options accessible by a user 106 to confirm or reject a pairing. In some implementations, the touchscreen 110 may present a prompt to input a validation code or other data, which may be displayed on the touchscreen 302 of the computing device 112 to be paired, and the user 106 may enter the validation code via the touchscreen 110. Alternatively, or in addition, the validation code may include a passcode, address, other data, and so forth. Upon input of acceptance, the validation code, or a combination thereof, the pairing module 326 may generate pairing data indicative of the relationship. The pairing module 326 may also send a pairing response to the computing device 112. In some implementations, the pairing module 326 may implement one or more techniques for pairing. For example, the pairing module 326 may utilize a Diffe-Hellman key exchange or another pairing technique. The pairing establishes a trust relationship and optionally secure communication between the secure payment terminal 104 and the computing device 112.

The SCE 322 may further include a cryptocurrency (or digital currency) module 330 that may facilitate interactions with the one or more blockchain servers 202 and which may control transfer of blockchain asset data from the blockchain to the mobile wallet application 310 of the computing device 112 for storage as off-chain asset data 320 or may control transfer of the blockchain asset data from the blockchain to the device 102 for storage as off-chain asset data 234 in the data store 226. For example, the secure payment terminal 104 may generate a signed message using public keys 336, private keys 338, passcode data 340, or any combination thereof (in response to input received via the touchscreen 110 or from the paired computing device 112) and may send the signed message to the one or more blockchain servers 202 to download blockchain data associated with a blockchain asset and store the blockchain data as off-chain asset data 234 in the data store 226 of the device 102. Alternatively, the secure payment terminal 104 may download blockchain data associated with a blockchain asset and provide it to the computing device 112, which may store the blockchain data as off-chain asset data 320 in the secure data store 314. The off-chain asset data 320 and 234 may include a digital currency value, time stamp data, date data, private key data, transaction ID data, other data, or any combination thereof. It should be appreciated that the blockchain asset data downloaded from a particular blockchain asset may be stored in only one memory location. Accordingly, off-chain asset data 320 is not the same as off-chain asset data 234.

The SCE 322 may also include a device module 332 that may cause the secure payment terminal 104 to detect insertion of a device 102 in one of the device slots 108. Additionally, the device module 332 may control the I/O devices 324 to establish communication with the device 102 and to control communications between components of device slots 108 and the device 102. For example, the device module 332 may provide data indicative of a blockchain asset from the blockchain data 204 to the device 102 for storage in the data store 226 as the off-chain asset data 234. Other implementations are also possible.

The SCE 322 may also include a data store 334 including one or more public keys 336, which may be used to establish secure communications with other devices through the network 206. In some implementations, the public key 336 may be implemented as a physically unclonable function (PUF). The data store 334 may also include private keys 338, which may be used to digitally sign cryptocurrency transactions, such as messages to redeem a digital currency value to the blockchain. The data store 334 may further include passcode data 340, which may be used to authenticate a user 106 to the secure payment terminal 104. Other components and elements are also possible.

In some implementations, the device 102 may be loaded with off-chain asset data 234 using the secure payment terminal 104. For example, a user 106 may insert the device 102 into the device slot 108 and may interact with the touchscreen 110 to transfer blockchain asset data from the blockchain data 204 to the data store 226 of the device 102 for storage as off-chain asset data 234. The off-chain asset data 234 may be stored together with a transaction ID and other information. When the device 102 uses the off-chain asset data 234 to generate a payment transaction 120, the transaction ID and other information may be included, and the recipient device 102 of the payment transaction 120 may use one of the settlement models 224 to validate the payment transaction 120 based on the transaction ID and other information and to complete the payment transaction 120.

In other implementations, the device 102 may be loaded with the off-chain asset data 234 using the secure payment terminal 104 in communication with the computing device 112. For example, a user 106 may insert the device 102 into a device slot 108. The user 106 may interact with the computing device 112 to establish communication with the secure payment terminal 104 and to initiate a transfer of blockchain asset data from the blockchain data 204 to a unique address associated with the device 102. The secure payment terminal 104 may receive the blockchain asset data and may provide the blockchain asset data to the device 102 for storage in the data store 226 as off-chain asset data 234. In this example, the touchscreen 110 of the secure payment terminal 104 may present a display and user-selectable options accessible by a user 106 to confirm the transfer, for example, by entering a passcode corresponding to passcode data 340, a pin, or other authenticating data. Other implementations are also possible.

When a secure payment terminal 104 is used to transfer blockchain asset data from the blockchain data 204 to the device 102, the secure payment terminal 104 may manage the security and the encryption. Once the off-chain asset data 234 is stored in the data store 226 in the SCE 218 of the device 102, the secure payment terminal 104 or a POS payment terminal 118 may facilitate communications, but the device 102 may establish the secure communications and the authentication of the other device 102, and may process the payment transaction 120 to transfer off-chain asset data 234.

Thus, the device 102 provides a particular advantage over conventional systems and devices in terms of the ease of use of cryptocurrencies, by allowing for processing of cryptocurrency transactions off-chain. The device 102 manages its own security, thereby allowing for use of POS payment terminals 118.

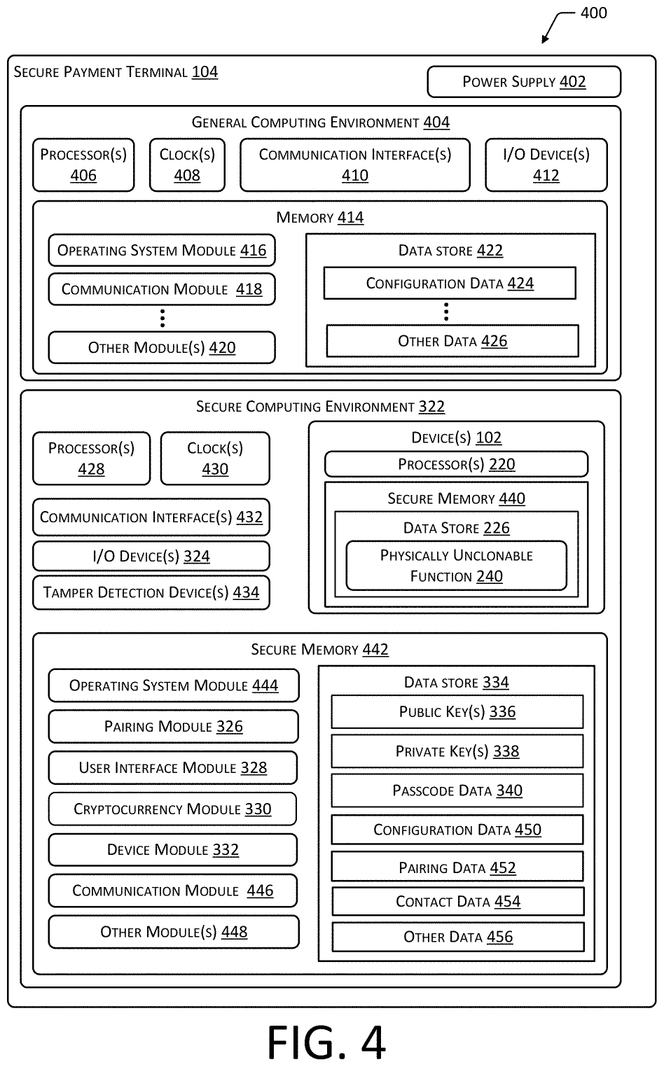

FIG. 4 depicts a block diagram 400 of a secure payment terminal 104 that may be used with the systems of FIGS. 1 through 3, according to one possible implementation. The secure payment terminal 104 may include a power supply 402. For example, the power supply 402 may transform alternating current at a first voltage obtained from a household outlet to direct current at a second voltage. In some implementations other devices may be used to provide electrical power to the secure payment terminal 104. For example, power may be provided by wireless power transfer (such as an inductive charging plate), batteries, photovoltaic cells, capacitors, fuel cells, and so forth.

The secure payment terminal 104 may comprise a general computing environment (GCE) 404. The GCE 404 may include one or more hardware processors 406 (processors) configured to execute one or more stored instructions. The processors 406 may comprise one or more cores. The processors 406 may include microcontrollers, systems on a chip, field programmable gate arrays, digital signal processors, graphic processing units, general processing units, and so forth. One or more clocks 408 may provide information indicative of date, time, ticks, and so forth.

The GCE 404 may include one or more communication interfaces 410. The communication interfaces 410 enable the GCE 404, or components thereof, to communicate with other devices or components. The communication interfaces 410 may include one or more of Inter-Integrated Circuit (I2C), Serial Peripheral Interface bus (SPI), Universal Serial Bus (USB) as promulgated by the USB Implementers Forum, RS-232, Ethernet, Wi-Fi, Bluetooth, Bluetooth Low Energy, ZigBee, long term evolution (LTE), and so forth. For example, the GCE 404 may include a Wi-Fi interface that allows the secure payment terminal 104 to communicate with the network 206 or a Zigbee interface that allows the secure payment terminal 104 to communicate with other devices.

The GCE 404 may include one or more I/O devices 412. The I/O devices 412 may include input devices such as one or more of a switch, keyboard, touch sensor, and so forth. The I/O devices 412 may also include output devices such as one or more of a light, speaker, display, and so forth. In some embodiments, the I/O devices 412 may be physically incorporated within the secure payment terminal 104 or may be externally placed.

As shown in FIG. 4, the GCE 404 may include one or more memories 414. The memory 414 may comprise one or more non-transitory computer-readable storage media (CRSM). The CRSM may be any one or more of an electronic storage medium, a magnetic storage medium, an optical storage medium, a quantum storage medium, a mechanical computer storage medium, and so forth. The memory 414 provides storage of computer-readable instructions, data structures, program modules, and other data for the operation of the GCE 404. A few example functional modules are shown stored in the memory 414, although the same functionality may alternatively be implemented in hardware, firmware, or as a system on a chip (SoC).

The memory 414 may include at least one operating system (OS) module 416. The OS module 416 is configured to manage hardware resource devices such as the communication interfaces 410 or the I/O devices 412, and to provide various services to applications or modules executing on the processors 406. For example, the OS module 416 may implement a variant of the Linux operating system, such as FreeBSD, which is an operating system promulgated by the FreeBSD Project associated with The FreeBSD Foundation.

The memory 414 may store one or more of the following modules. These modules may be executed as foreground applications, background tasks, daemons, and so forth. For example, the memory 414 may store a communication module 418 and one or more other modules 420. The communication module 418 may be configured to use one or more of the communication interfaces 410 to facilitate communication between other devices and the GCE 404. For example, the communication module 418 may use a network interface to establish a connection to a Wi-Fi wireless access point and receive message data from one of the devices, such as a computing device 112. The communication module 418 may then provide the message data to the SCE 322. In some implementations the communication module 418 may provide for encrypted communications through the network interface. The OS module 416, the communication module 418, or other modules 420 may provide additional functions such as network security, denial of service attack mitigation, port scanning detection, and so forth. In the event a potential attack is detected, the GCE 404 may take mitigating actions. For example, the GCE 404 may temporarily disconnect network access, acquire a new network address using a dynamic host configuration protocol, suspend communication with the SCE 322, and so forth.

Also, the memory 414 may include a data store 422. The data store 422 may use a flat file, database, linked list, tree, executable code, script, or other data structure to store information. The data store 422 may include configuration data 424. For example, the configuration data 424 may include connection parameters for the network interface. Other data 426 may also be stored in the data store 422.

The secure payment terminal 104 may also comprise an SCE 322. The SCE 322 may include one or more hardware processors 428 (processors) configured to execute one or more stored instructions. The processors 428 may comprise one or more cores. The processors 428 may include microcontrollers, systems on a chip, field programmable gate arrays, digital signal processors, graphic processing units, general processing units, and so forth. One or more clocks 430 may provide information indicative of date, time, ticks, and so forth.

The SCE 322 may include one or more communication interfaces 432. The communication interfaces 432 enable the SCE 322, or components thereof, to communicate with other devices or components, including components of the GCE 404. The communication interfaces 432 may include one or more of I2C, SPI, USB, RS-232, secure digital host controller (SDHC), device interface, near-field communication (NFC) interface, and so forth. In some implementations, communication between the GCE 404 and the SCE 322 may be limited to a particular communication bus, such as SPI or USB, and may be provided by the communication interfaces 432.

The SCE 322 may include one or more I/O devices 324. The I/O devices 324 may include input devices such as one or more of a switch, keyboard, touch sensor, and so forth. The I/O devices 324 may also include output devices such as one or more of a light, speaker, display, and so forth. For example, the I/O devices 324 may include a touchscreen 110 that incorporates a display and a touch sensor, allowing for the presentation of data and acquisition of input. In some implementations, these I/O devices 324 may be constrained such that they may only be accessed by the SCE 322, and not the GCE 404.

The SCE 322 provides security against algorithmic and physical forms of intrusion. For example, the separation between the GCE 404 and the SCE 322, as well as other attributes of the SCE 322, minimizes the likelihood of success of an algorithmic attack. To guard against physical attack, the SCE 322 may include, or be in communication with, one or more tamper detection devices 434.

The tamper detection devices 434 provide data indicative of actual or potential tampering with the SCE 322 or elements therein. For example, the tamper detection devices 434 may include switches that indicate that the case of the secure payment terminal 104 has been opened. In another example, the tamper detection devices 434 and circuitry may include electrical conductors that, when broken, signal physical tampering. In another example the tamper detection devices 434 may include sensors such as temperature sensors, light sensors, voltage measurement devices, magnetic field sensors, ionizing radiation sensors, ultrasonic sensors, and so forth may provide data that is indicative of tampering. The tamper detection devices 434 may be used to detect tampering of components that are part of a single die, a circuit board, an assembly, the SCE 322, and so forth. For example, the I/O devices 324 may include tamper detection devices 434. These anti-tamper devices may be powered by a battery, which may be part of the secure payment terminal 104 and may be contained within tamper detection devices 434.

In some implementations, the SCE 322 or portions thereof may be configured to self-destruct or otherwise be rendered unusable responsive to tampering. For example, responsive to a determination of tampering, voltage exceeding a threshold value may be passed through at least a portion of the circuitry in the SCE 322, rendering the circuitry unusable. In another example, responsive to a determination of tampering, the tamper detection device 434 may cause the storage media (such as secure memory 440) to be erased, overwritten, randomized, and so forth.

The SCE 322 may include or may be coupled to one or more devices 102. In the illustrated example, the device 102 may be integral with the SCE 322 or secure payment terminal 104, or may be removeable (such as through the device slots 108), or may be wirelessly connected. The device 102 may include one or more processors 220, a secure memory 440, and other components. For example, the processor 220 may be configured to provide one or more cryptographic functions, to apply settlement models 224, and to enforce blockchain rules to conduct payment transactions involving off-chain asset data. The secure memory 440 may include a data store 226 that may be used to store one or more secrets, such as private keys 230, a certificate data 232, a digital asset 234, a list of trusted certificates data 236, and optionally salt data 238 for use in sending payment transactions 120. Additionally, the data store 334 of the secure memory 440 may include a physically unclonable function (PUF) 240 that may be used in payment transactions 120, for example, as a public key. In some implementations, the PUF 240 may be used as a public key within the blockchain that may be used to encumber a blockchain asset when the blockchain data 204 is downloaded from the blockchain. The PUF 240 may be based on some characteristic of the device 102 or a component therein that exhibits physical variation during fabrication. The PUF 240 may be used to produce data that is unique to that particular device 102. Physical variable features may be used to generate the PUF 240. For example, the PUF 240 may be generated based on physical characteristics such as the distribution of coatings, arrangement of a crystalline lattice, arrangement of magnetic particles, a circuit with a repeatable race condition the result of which is not known prior to manufacture, and so forth. In some implementations, the PUF 240 may be used as a private key 230, or as pseudo random seed data to generate a private key 230.

Communication between the secure payment terminal 104 and the device 102 may be established using one or more electrical contacts, or wirelessly using electromagnetic radiation, magnetic fields, sound, and so forth. For example, the communication interfaces 432 may include an interface that utilizes electrical contact with the device 102 and is compliant with the International Organization for Standards (ISO) and International Electrotechnical Commission (IEC) ISO/IEC 7816-4:2013 standard. For example, the communication interfaces 432 may comply with Part 1 (Cards with contacts—Physical characteristics); Part 2 (Cards with Contacts—Dimensions and Location of the Contacts); and Part 3 (Cards with Contacts—Electrical Interface and Transmission Protocols). In another example, the communication interfaces 432 may include a wireless interface that is compliant with at least a portion of the ISO/IEC 14443-1:2018, such as Section 4 (Physical Characteristics). It should be understood that these standards evolve, and the communication interfaces 432 may be changed to meet or exceed specifications defined by the standards.

As shown in FIG. 4, the SCE 322 includes one or more memories, referred to as secure memory 442. The secure memory 442 may comprise one or more computer-readable storage media (CRSM). The CRSM may be any one or more of an electronic storage device, a magnetic storage device, an optical storage device, a quantum storage device, a mechanical computer storage device, and so forth. The secure memory 442 may provide storage of computer-readable instructions, data structures, program modules, and other data for the operation of the SCE 322. A few example functional modules are shown stored in the secure memory 442, although the same functionality may alternatively be implemented in hardware, firmware, or as a system on a chip (SoC).

In some implementations, the secure memory 442 may include a memory controller that is internal to the secure memory 442 and that is configured to encrypt all data written to the secure memory 442 using a private key, such as one of the private keys 338 that are maintained within the secure memory 442. In response to detection of tampering by the tamper detection devices 434, the secure memory 442 may delete or overwrite the private keys 338, rendering data stored in the secure memory 442 inaccessible. Other implementations are also possible.

The secure memory 442 may include at least one operating system (OS) module 444. The OS module 444 is configured to manage hardware resource devices such as the communication interfaces 432 or the I/O devices 324, and to provide various services to applications or modules executing on the one or more processors 428. For example, the OS module 444 may implement a variant of the Linux operating system, such as FreeBSD (which is an operating system promulgated by the FreeBSD Project at www.freebsd.org) or FreeRTOS (a free real time operating system distributed by Amazon Technologies, Inc.), bare metal c, or another operating system.

The secure memory 442 may store one or more of the following modules. These modules may be executed as foreground applications, background tasks, daemons, and so forth. These modules may include one or more of a pairing module 326, a user interface module 328, a cryptocurrency module 330, a device module 332, a communication module 446, or other modules 448.

The pairing module 326 may control an operation in which the computing device 112 and the secure payment terminal 104 establish secure communications and a trust relationship, through which the computing device 112 may initiate download of blockchain asset data from the blockchain onto the device 102, which stores the blockchain asset data as off-chain asset data 234. Pairing indicates an established and trusted relationship between the secure payment terminal 104 and another device or system. For example, the communication module 446 may receive message data from the GCE 404 that comprises data associated with pairing, such as a source identifier, a source address, a public key 316, and so forth. The communication module 446 passes the message data to the pairing module 326 for processing.

The pairing module 326 may use the user interface module 328 to present a user interface via the I/O devices 324 in the SCE 322. For example, the user interface module 328 may present a prompt on a touchscreen 110 requesting user-input to confirm the pairing. In some implementations, the graphical interface presented to the touchscreen 110 may include a prompt requesting input of a validation code, passcode, or other data. Upon entry of approval of the validation code, the passcode, or a combination thereof, the pairing module 326 may generate pairing data 452 indicative of the relationship. The pairing module 326 may then send a pairing response to the GCE 404, that ultimately is transmitted to the other device. The pairing module 326 may implement one or more techniques for pairing, such as, for example, a Diffe-Hellman key exchange. In another example, the pairing module 326 may include a user input method in which the user 106 is prompted to enter various passcodes, a matching method in which the user 106 may compare outputs of devices to establish or reject a connection, a guidance method in which the user 106 may initiate a pairing and follow onscreen instructions to verify and establish the pairing, an audio-visual synchronization method in which the devices may interact with one another in close proximity, an enrollment method in which passwords are shared, other methods, or any combination thereof.

During pairing, some data may be transferred over the network 206, which data may be received at the SCE 322 via the GCE 404. For example, the secure payment terminal 104 and the other device (such as the computing device 112) may exchange public keys (such as public keys 316 and 336, respectively), signed messages, synchronization data, other data, and so forth. In some implementations, the communication module 446 may assess incoming message data. For example, the communication module 446 may assess values of the incoming message data against one or more of the pairing data 452 or other data 456, or any combination thereof.

Also stored in the secure memory 442 may be the data store 334. The data store 334 may use a flat file, database, linked list, tree, executable code, script, or other data structure to store information. The data store 334 may include one or more public keys 336, one or more private keys 338, and one or more passcodes 340. The data store 334 may also include one or more of configuration data 450, pairing data 452, contact data 454, or other data 456. For example, the configuration data 450 may comprise settings associated with operation of the OS module 444, data indicative of the limits imposed by the communication module 446, and so forth.

The contact data 454 may include data related to a currently paired session as well as information about the paired device. Additionally, the contact data 454 may include image data and other data associated with cryptocurrency accounts to which the secure payment terminal 104 has previously sent blockchain asset data. In one possible example, when a user 106 is interacting with the touchscreen 110 to transfer blockchain asset data to an account, an image of a user 106 or company associated with the account may be displayed within the graphical interface to allow the user 106 to verify visually that the correct account has been selected. For example, if the user 106 wants to transfer blockchain asset data to Bob, the user 106 may select contact data 454 associated with Bob using the touchscreen 110 and the graphical interface may display an identifier, such as a picture of Bob, so that the user 106 may readily confirm that the correct account has been selected. Other implementations are also possible.

The other data 456 may include threshold data and other data that may be used to assess values of the incoming message data. Further, in some implementations, the communications module 446 may be configured to disregard message data that is not associated with a paired device as indicated in the pairing data 452 and the contact data 454. For example, a paired computing device 112 may send message data to the secure payment terminal 104 for signing. The communications module 446 may verify a source address, signature data, or other values in the message data to determine if the message data is associated with pairing data 452 indicative of a pairing that is still active. Each pairing, as indicated in the pairing data 452, may have one or more different rules or conditions associated with that pairing. These conditions may specify limits designated by a user 106, an administrator, and so forth. Alternatively, the conditions may specify limits that are automatically determined by the pairing module 326 during the process of establishing the pairing. Once the pairing is established, the pairing module 326 may generate or update pairing data 452 in the data store 334.

The user interface module 328 may control information provided to the touchscreen 110 of the secure payment terminal 104, including images, text, and user-selectable options accessible by a user 106 via the touchscreen 110 to complete a transfer operation, transferring the blockchain asset data from the blockchain data 204 onto the device 102 for storage as off-chain asset data 234. In some implementations, the touchscreen 110 may present an interface through which a user 106 may be required to enter a passcode, which must match the passcode data 340 in order to complete the download transaction.

The cryptocurrency module 330, in addition to managing cryptocurrency communications with the one or more blockchain servers 202, may perform one or more cryptographic functions. These cryptographic functions may include, but are not limited to, private key generation, creation of one or more pieces of a private key 338 for sharing, hierarchically deterministic address generation, digital signing, hash generation, multiple signature signing, encryption, decryption, and so forth. For example, the cryptographic functions may include an implementation of secret sharing, such as described by Adi Shamir, George Blakely, and so forth, that allow for a secret to be divided into several pieces that may then be distributed. The private key 338 may then be determined using the pieces, or a subset of those pieces. In another example, the cryptographic functions may produce, based on one or more of the private keys 338, a digital signature that is used to create the signed message data.

The device module 332 may be configured to manage hardware resource devices, such as the I/O devices 412, I/O devices 324, and communication interfaces 432 to establish communication between the secure payment terminal 104 and one or more devices 102. Further, the device module 332 may cooperate with the cryptocurrency module 330 to store off-chain asset data 234 onto the device 102 or to receive the off-chain asset data 234 for redemption to the blockchain data 204. Other implementations are also possible.

The communication module 446 may use one or more of the communication interfaces 432 to provide communication between the SCE 322 and the GCE 404. The communication module 446 may implement mailbox functionality, restricting the type of data that may be transferred between the SCE 322 and the GCE 404. The communication module 446 may restrict communication based on frequency of data transfer, size of the data, type of data being transferred, implement a limited set of instructions, and so forth. For example, if the communication module 446 receives message data from the GCE 404 that is too large (for example, larger than a predetermined threshold), the communication module 446 may erase the message data. In another example, the communication module 446 may suspend communications when a number of messages per unit time exceeds a threshold value. In some implementations, if the communication module 446 or other module 448 detects activity that exceeds one or more thresholds, mitigating actions may be taken. These mitigating actions may include, but are not limited to, erasure of the secure memory 442 (and optionally the secure memory of the device 102), rendering one or more components of the SCE 322 inoperable, and so forth. For example, if the number of invalid instructions processed by the communication module 446 exceeds a threshold count within a predetermined period of time, the secure memory 442 may be erased. Likewise, the communication module 446 may impose limits on outbound communication to the GCE 404.

Continuing the earlier example, after determining a valid pairing exists, the communication module 446 may compare one or more other values of the message data to thresholds and other data 456 to determine if the one or more values satisfy the thresholds. The other data 456 may indicate particular fields of data and the corresponding boundary values for those fields. For example, the field may specify a “type of currency” and the boundary value may specify “ETH” or “Ethereum.” The other data 456 may be used to specify one or more of a type of asset that is permitted, a type of transaction that is permitted, a maximum number of signed messages within a specified interval of time, a maximum quantity of assets in a single transaction, a minimum quantity of assets in a single transaction, a maximum quantity of assets transferred per interval of time, corresponding boundary values, types of digital assets, and so forth.

The conditions specified by the other data 456 may include a requirement for verification by entering via the touchscreen 110 a passcode or other authorizing indicia that matches passcode data 340 before the signed message data (such as an off-chain asset data redemption message to be sent to the blockchain to redeem the off-chain asset data 234) is determined. For example, the user interface module 328 may be used to accept input from the touchscreen 110 indicative of approval to sign the message data.

In one possible implementation, the input received via the touchscreen 110 may comprise a passcode that, when entered using the I/O device 324 and subsequently validated against the passcode data 340, is used to access one or more of the private keys 338. For example, the passcode may be verified against the passcode data 340 to authorize or otherwise indicate use of a “blind” private key 338. In another implementation, instead of or in addition to the passcode, a removeable device 102 may be utilized, onto which the off-chain asset data 234 may be loaded. In one possible implementation, the SCE 322 may use the removeable device 102 as a form of second factor authentication or removable security dongle, which may be required to be inserted before authentication may be confirmed.

Public key 336 values, cryptocurrency addresses, and other data associated with transactions involving cryptography may be troublesome for the user 106 to deal with. Humans may have difficulty working with long sequences of letters and numbers. For example, humans may have difficulty discerning small differences between those strings, remembering a cryptocurrency address, and so forth. As a result, there is the potential for the user 106 to incorrectly select one cryptocurrency address when another is intended, or otherwise introduce errors into the process of generating the signed message data. The user interface module 328 may be used to provide, with the I/O devices 324, contact data 454 that is associated with the message data. In one implementation, the user interface module 328 may use the destination address in the message data to retrieve a particular record from the contact data 454. For example, if the message data is a payment transaction 120 that includes the destination address which matches an entry in the contact data 454, such as an address associated with “Utility Company, Inc”, the name in the contact data and a picture of the “Utility Company, Inc.” logo may be presented on the touchscreen 110. For example, the touchscreen 110 may present a user interface including prompts requesting a user 106 to provide an approval to the transaction, enter a passcode, and so forth. By presenting this information (including the contact data 454) in the graphical interface via the touchscreen 110, the user 106 may quickly and easily see who the recipient is of that transaction. This presentation may facilitate discovery of unwanted or incorrect transactions being signed. As a result, overall security of the secure payment terminal 104 and of the system is improved.

The other modules 448 may provide other functions. For example, the other modules 448 may provide email or messaging functionality to provide an alert to a predetermined phone number or email account when a transaction is initiated or completed. Other functions are also possible.

Data and capabilities of the devices 102 may be accessed while the device 102 is operating as part of the SCE 322. For example, the secure payment terminal 104 may connect to a device 102 via one of the device slots 108. Once connected, the SCE 322 may utilize the private key 230 that is stored in the secure memory of the device 102, utilize cryptographic functions (such as the PUF 240) on the device 102, and so forth.

In some implementations, in addition to providing a secure environment for one or more devices 102 to be accessed, the SCE 322 may provide one or more secure input/output (I/O) devices 324. For example, the I/O devices 324 may include a touchscreen 110 that incorporates a display and a touch sensor, allowing for the presentation of a user interface including data and selectable options to a user 106 and acquiring input from the user 106. In some implementations, the secure payment terminal 104 may acquire biometric data, including but not limited to fingerprint data, palmprint data, iris data, and so forth, using the touchscreen 110, a separate biometric input interface, or any combination thereof. The I/O devices 324 may allow the SCE 322 to accept input such as pairing codes (pairing data 452), passcodes (passcode data 340), biometric data, address data, or other data in a way that is deemed highly secure and is independent of the network 206 that the GCE 404 is connected to. For example, the input provided via the touchscreen 110, the biometric sensor (if included), the inserted device 102, or any combination thereof may be used for initial verification, second factor verification, or even tertiary factor verification.

The SCE 322 may accept as input, or generate internally, a message that may then be signed using one or more of the private keys 230 in the secure memory of the device 102 (or private keys 338 of the secure memory 442 of the secure payment terminal 104) to produce signed message data (such as a payment transaction 120). The signing operation may be dependent on values in the message satisfying one or more previously specified conditions. For example, the SCE 322 (or the device 102) may implement rules that limit signing based on the identity of the party requesting the signature, type of cryptocurrency, an amount of transfer, frequency of transfer, destination address, and so forth. Continuing the example, the SCE 322 (or the device 102) may permit signing of a request for an amount of Ethereum that is below a threshold value, provided that there haven't been other transfers in the last 24 hours, and provided that the destination address in the request matches an address that was previously stored in the SCE 322 (such as in contact data 454) or that includes a certificate data 232 that matches a list in the trusted certificate issuers data 236. In this example, if the message satisfies the conditions, the SCE 322 (or the device 102) may create the signed message data.

In some implementations, the rules may require user 106 approval of the signing using the I/O devices 324 (such as via the touchscreen 110) of the SCE 322. For example, if the amount of the proposed transfer exceeds the threshold value, a graphical interface may be presented on the touchscreen 110 of the SCE 322 that includes a request of entry of a passcode or other indicia of approval of the signing. Once the indicia of approval are received, the secure payment terminal 104 may sign the message (such as a payment transaction 120), and may send the signed message from the SCE 322 to the GCE 404. The GCE 404 may then send the signed message to one or more blockchain servers 202 (to redeem off-chain asset data 234 included in the signed message) or to other external devices, such as to another device 102 through a POS payment terminal 118, through another secure payment terminal 104, and so on.

The secure payment terminal 104 may further improve security by providing contact data 454 in a user interface via the output device (I/O devices 324 including the touchscreen 110). For example, the user interface presented on the touchscreen 110 may include data and information allowing the user 106 to more easily confirm (visually) who the beneficiary of a signed message is. In a particular example, the secure payment terminal 104 may include contact data 454, which may store a picture of George and his Ethereum cryptocurrency address. When message data is received requesting a transfer to George's Ethereum address, George's name and picture may be presented within a graphical interface on the touchscreen 110, along with a confirmation prompt, allowing a user 106 to readily determine whether the recipient is correct. This presentation of contact data 454 may significantly improve the reliability and usability of the secure payment terminal 104. For example, this simplified interface may assist the user 106 to prevent transfer of digital assets to an incorrect party.

In some implementations, other computing devices 112 (such as a smartphone) or systems may be paired with the secure payment terminal 104, providing enhanced functionality. Pairing may indicate an established and trusted relationship between the secure payment terminal 104 and the other computing device 112 or system. During pairing, some data may be transferred over the network 206, such as received at the SCE 322 via the GCE 404. For example, the secure payment terminal 104 and the other device 112 may exchange public keys (public keys 228 and 316, respectively). The certainty of the pairing may be further improved by requiring the transfer of out-of-band (OOB) data to complete the pairing. For example, the touchscreen 110 of the secure payment terminal 104 may present information as well as selectable options accessible by the user 106 to enter a first authorization code that has been provided by the other device, for example, on the touchscreen 302 interface of the computing device 112. The touchscreen 110 of the secure payment terminal 104 may also present a graphical interface including a second authorization code, that may then be provided via OOB communication to the other device. For example, while setting up a pairing with the computing device 112, the computing device 112 may initiate communication with the secure payment terminal 104. The computing device 112 may display an authorization code on the touchscreen 302, which may be entered via the touchscreen 110 of the secure payment terminal 104, and the user 106 may receive a second authorization code displayed by the touchscreen 110, which may be entered on the computing device 112 via the touchscreen 302. Upon entry of valid authorization codes, the pairing may be complete.

The pairing functionality allows the secure payment terminal 104 to provide signing capabilities to devices, such as the computing device 112, that are less secure than the secure payment terminal 104. For example, the user 106 may pair their smartphone (which is an example of a computing device 112) with their secure payment terminal 104. Once paired, the smartphone may be used to generate message data that is sent to the secure payment terminal 104, for example, to load blockchain asset data onto a device 102, which stores the blockchain asset data as off-chain asset data 234. The message data is passed to the SCE 322, where the values in the message data are checked to determine if they satisfy previously specified conditions. This checking process may include determining that the message data is associated with a valid pairing, is within the boundaries specified by the conditions, and so forth. In some situations, the user 106 may be prompted to authorize the signing using the touchscreen 110 of the secure payment terminal 104, further enhancing security. Once approved, either automatically by satisfying the conditions, or after approval that has been manually entered, the SCE 322 may generate the signed message data, which is then provided to an external device. Continuing the example, the smartphone may generate message data specifying a payment using a cryptocurrency. The smartphone (computing device 112) may send the request to the secure payment terminal 104 that has been previously paired. Because the requested amount is less than a threshold amount and comes from a paired device, the secure payment terminal 104 may automatically sign the message, and the signed message data may be sent to the smartphone. The smartphone may then send the signed message data to the website, to the appropriate blockchain servers 202, and so forth.

The secure payment terminal 104 supports various functions such as blind-key storage, multiple signature signing, distribution of a private key across several different devices, such as secure devices, devices 102, and so forth. Blind-key storage allows for the storage of a private key 338 within the secure memory 442 of the SCE 322 which is not known outside of the secure memory 442. In order to use a blind private key 338, the user 106 may be directed to enter a passcode using the touchscreen 110 of the secure payment terminal 104. Entry of a valid passcode (as compared to the passcode data 340) may cause the secure payment terminal 104 to utilize the private key 338 for signing or other cryptographic operations, without revealing the blind private key 338.

Multiple signature signing facilitates situations in which a plurality of private keys 338 may be used to sign a message. For example, message data may need to be signed using three different private keys, such as a private key 230(1) of a first device 102(1), a private key 230(2) of a second device 102(2), and a private key 338 of the secure payment terminal 104, in a particular order, in order to generate signed message data that is deemed valid and suitable for inclusion into the blockchain data 204. This is an example of a meta-protocol utilizing individual digital signatures as atomic units.

Multiple signature signing may also be used to improve durability of secrets by allowing for a loss or inaccessibility of some secrets. For example, multiple signature signing may allow for a situation in which a subset of private keys 338 may be used to produce signed message data. In this implementation, the secure payment terminal 104 may generate signed message data when at least N of M private keys 338, or their resulting digital signatures, are present (where N and M are non-zero positive integers and N<M). For example, valid signed message data may be generated when 2 of 3 private keys 230(1), 230(2), and 338 are available for signing. This improves durability preventing loss of capability, such as the ability to generate signed message data, should one of the three keys be unavailable, such as due to loss or theft. Continuing the example, the user 106 may have a first private key 230(1) stored on a first device 102(1), and a second private key 230(2) stored on a second device 102(2), and a third private key 338 in the secure payment terminal 104. The second device 102(2) may be safely stored at another geophysical location. In the event that any one private key 338 or 230(1) or 230(2) is unavailable, the other two private keys may still be used, preventing loss of the off-chain asset data 234 to the user 106 because of inaccessibility.

The secure payment terminal 104 may interact with other devices and facilitate various transactions between parties. For example, the secure payment terminal 104 in a user's 106 home may be in communication with a thermostat, smart electric meter, photovoltaic systems, battery storage system, and so forth. The user 106 may store a private key 338 for a cryptocurrency account in the secure payment terminal 104 and may establish secure pairing and conditions with an electric utility company. The user 106 may have an agreement with the utility allowing for mutually cooperative operation. For example, as electrical demands peak in the short term, the user's 106 thermostat may be adjusted to reduce power consumption while a battery storage system provides power back to the utility.

The secure payment terminal 104 may also be used to transfer value to a computing device 112 or to a device 102 using digitally signed message data. So long as the pairing remains in place and the conditions for a requested transfer of value are met, the secure payment terminal 104 will sign message data (including off-chain asset data 234). The signed message data may then be provided to blockchain servers 202 to commit the off-chain asset data 234 to the blockchain data 204, transferring value to a designated address.

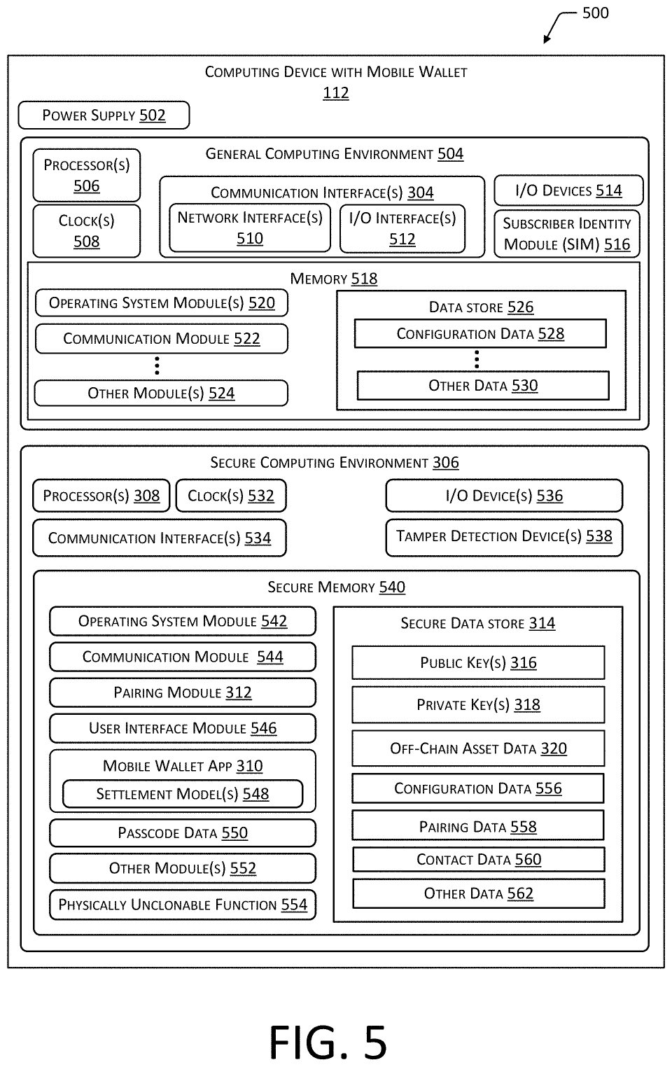

FIG. 5 depicts a block diagram 500 of a computing device 112 with a mobile wallet that may be used with the systems of FIGS. 1 through 3, according to one possible implementation. The computing device 112 may include one or more power supplies 502 to provide electrical power suitable for operating the components of the computing device 112. In some implementations, the power supply 502 may include a rechargeable battery.

The computing device 112 may further include a general computing environment (GCE) 504, which may include one or more hardware processor(s) 506 configured to execute one or more stored instructions. The processor(s) 506 may include one or more cores. One or more clocks 508 may provide information indicative of date, time, ticks, and so forth. For example, the processor(s) 506 may use data from the clock 508 to generate a timestamp, trigger a preprogrammed action, and so forth. The computing device 112 may include one or more busses or other internal communications hardware or software that allows for the transfer of data between the various modules and components of the computing device 112.

The computing device 112 may include one or more communication interfaces 304, such as one or more network interfaces 510, one or more input/output (I/O) interfaces 512, and so forth. The network interfaces 510 may enable the computing device 112, or components of the computing device 112, to communicate with other devices. The I/O interfaces 512 may include interfaces such as Inter-Integrated Circuit (I2C), Serial Peripheral Interface bus (SPI), Universal Serial Bus (USB) as promulgated by the USB Implementers Forum, RS-232, and so forth. In some implementations the I/O interface(s) 512 may couple to one or more I/O devices 514. The I/O devices 514 may include any manner of input device or output device associated with the computing device 112. For example, I/O devices 514 may include touch sensors, keyboards, mouse devices, microphones, image sensors (e.g., cameras), scanners, displays, speakers, haptic devices, printers, positioning devices, and so forth. In some implementations, the I/O devices 514 may be physically incorporated with the computing device 112 or may be externally placed.

The network interfaces 510 may be configured to provide communications between the computing device 112 and other devices, such as routers, access points, and so forth. The network interfaces 510 may include devices configured to couple to one or more networks 206, including local area networks (LANs), WLANs, wide area networks (WANs), WWANs, and so forth. For example, the network interfaces 510 may include devices compatible with Ethernet, Wi-Fi, Bluetooth, ZigBee, Z-Wave, 3G, 4G, LTE, and so forth. Further, the network interfaces 510 may be configured to provide communications between the computing device 112 and the secure payment terminal 104.

The computing device 112 may include a subscriber identity module (SIM) 516. The SIM 516 may comprise a non-transitory computer-readable storage media that may store information such as an international mobile subscriber identity (IMSI) number, cryptographic keys, integrated circuit card identifier (ICCID), contact information, or other data. The SIM 516 may be used by the network interface 510 for communication with one or more of the networks 206. For example, the IMSI and cryptographic keys stored in the SIM 516 may be retrieved and used to establish communication with a communications network.

As shown in FIG. 5, the computing device 112 may include one or more memories 518 and 540. The memories 518 and 540 may include one or more non-transitory computer-readable storage media (CRSM). The CRSM may be any one or more of an electronic storage device, a magnetic storage device, an optical storage device, a quantum storage device, a mechanical computer storage device, a solid-state storage device, and so forth. The memories 518 and 540 may provide storage of computer-readable instructions, data structures, program modules, and other data for the operation of the computing device 112. A few example modules are shown stored in the memory 518, although the same functionality may alternatively be implemented in hardware, firmware, or as a system on a chip (SoC).

The memory 518 may include one or more operating system (OS) modules 520. The OS modules 520 may be configured to manage hardware resource devices such as the I/O interfaces 512 and the network interfaces 510, and to provide various services to applications or modules executing on the processors 506. The OS module 520 may implement a variant of the FreeBSD operating system as promulgated by the FreeBSD Project; UNIX or a UNIX-like operating system; a variation of the Linux operating system as promulgated by Linus Torvalds; the Windows operating system from Microsoft Corporation of Redmond, Washington, USA; the Mac OS or iOS promulgated by Apple Inc. of Cupertino, Calif., USA; or other operating systems.

The memory 518 may further include a communication module 522 configured to establish communications with one or more other devices using one or more of the communication interfaces 304. Communications may be authenticated, encrypted, and so forth. For example, the communication module 522 may utilize digital certificates to authenticate the identity of devices involved in the communication. In some implementations, the communication module 522 may be configured to establish a secure communications link with the secure payment terminal 104.

The memory 518 may also include other modules 524. Further, the memory 518 may include a data store 526. The data store 526 may use a flat file, database, linked list, tree, executable code, script, or other data structure to store information. In some implementations, the data store 526 may include configuration data 528 and other data 530. For example, the configuration data 528 may include network configuration data to enable communication between the computing device 112 and a network 206, which may include a short-range communications network, such as a local area network within a user's 106 home.

In some implementations, the computing device 112 may include components (hardware, software, or both) configured to implement an SCE 306. The SCE 306 may include one or more hardware processors 308, one or more clocks 532, one or more communications interfaces 534, one or more I/O devices 536, and one or more tamper detection devices 538.

The one or more processors 308 may be configured to execute instructions and to process data within the SCE 306. The one or more clocks 532 may provide information indicative of date, time, ticks, and so forth. The one or more communications interfaces 534 may enable the SCE 306, or components thereof, to communicate with other devices or components. The communication interfaces 534 may include one or more of I2C, SPI, USB, RS-232, secure digital host controller (SDHC), device interface, near-field communication (NFC) interface, and so forth. In some implementations, communication between the GCE 504 and the SCE 306 may be limited to a particular communication bus, such as SPI or USB, and may be provided by the communication interfaces 534.

The one or more I/O devices 536 may communicate data to and receive data from the GCE 504. Further, the I/O devices 536 communicate data to the touchscreen 302. Additionally, the I/O devices 536 may include an interface associated with the touchscreen 302 to detect inputs received from the touch-sensitive circuitry of the touchscreen 302.

The tamper detection devices 538 may be configured to provide data indicative of actual or potential tampering with the SCE 306 or elements therein. For example, the tamper detection devices 538 may include switches that indicate that the case of the computing device 112 has been opened. In another example, the tamper detection devices 538 and circuitry may include electrical conductors that, when broken, signal physical tampering. In another example the tamper detection devices 538 may include sensors. For example, temperature sensors, light sensors, voltage measurement devices, magnetic field sensors, ionizing radiation sensors, ultrasonic sensors, and so forth may provide data that is indicative of tampering. The tamper detection devices 538 may be used to detect tampering of components that are part of a single die, a circuit board, an assembly, the SCE 306, and so forth. For example, the I/O devices 536 may include tamper detection devices 538.

In some implementations, the SCE 306 or portions thereof may be configured to self-destruct or otherwise be rendered unusable responsive to tampering. For example, responsive to a determination of tampering, voltage exceeding a threshold value may be passed through at least a portion of the circuitry in the SCE 306, rendering the circuitry unusable. In another example, responsive to a determination of tampering, the tamper detection device 538 may cause the storage media to be erased, overwritten, randomized, and so forth. In still another example, the tamper detection device 538 may cause a memory controller of a secure memory 540 to delete or overwrite a private key 318 that is stored within the secure data store 314 and that is used to encrypt data written to the secure memory 540. Other implementations are also possible.

The SCE 306 may include the secure memory 540, which may utilize one of the private keys 318 to encrypt data stored within the secure memory 540. The secure memory 540 may store one or more operating systems (OS) modules 542, which may control operation of the various components. Further, the secure memory 540 may include a communication module 544 that may control communications between the SCE 306 and the GCE 504 via the communication interfaces 534.

In this example, the secure memory 540 may include a pairing module 312 that may control pairing operations between the SCE 306 and the secure payment terminal 104. The secure memory 540 may also include a user interface module 546, which may present a graphical interface to the touchscreen 302 via the communication interfaces 534. For example, the graphical interface may include text, images, and selectable options accessible by a user 106 to initiate transactions. In one possible example, the graphical interface may be part of the mobile wallet application 310. The mobile wallet application 310 may provide cryptocurrency transaction functionality, enabling the computing device 112 to send and receive payment transactions 120.

In some implementations, the mobile wallet application 310 may include one or more settlement models 548, which may be used to validate payment transactions 120 that include off-chain asset data 320 received from other computing devices 112 or that include off-chain asset data 234 received from a device 102. The one or more settlement models 548 may be the same as the settlement models 224 of the device 102, enabling the computing device 112 to send and receive payment transactions 120 and to validate the payment transactions 120 using the settlement models 548. Other implementations are also possible.

The secure memory 540 may also include passcode data 550, which may be compared to a passcode entered by a user 106 via the touchscreen 302 to authenticate the user 106. The secure memory 540 may further include other modules 552 that provide further functionality. In some implementations, the secure memory 540 may also include a physically unclonable function (PUF) 554, which may be used as a private key 318 or to generate one or more private keys 318.

The secure memory 540 may further include a secure data store 314 to store public keys 316, private keys 318, and off-chain asset data 320. The secure data store 314 may further include configuration data 556 corresponding to the setup the configuration details of the computing device 112. Further, the secure data store 314 may include pairing data 558 corresponding to the pairing between the computing device 112 and the secure payment terminal 104. Further, in some instances, the secure data store 314 may include contact data 560, such as pictures and account data associated with one or more recipients to which the user 106 may want to send a payment transaction 120. The secure data store 314 may also include other data 562.

In some embodiments, the user interface module 546 may present contact data 560, such as image data, identifying data, account data, and the like, to the touchscreen 302 to allow a user 106 to readily verify that the contact information matches the intended recipient. Other implementations are also possible.

In some implementations, the computing device 112 may utilize the mobile wallet application 310 to send and receive payment transactions 120 to and from other computing devices 112, devices 102, or both. Additionally, the computing device 112 may redeem off-chain asset data 320 to the blockchain either directly through the network 206 or via the secure payment terminal 104. Other implementations are also possible.

The settlement models 548 of the mobile wallet application 310 on the computing device 112 and the settlement models 224 of the device 102 enable off-chain validation of payment transactions 120 between devices 102, between computing devices 112, or between devices 102 and computing devices 112. In particular, the computing device 112 may use the settlement models 548 to validate one or more payment transactions 120 without committing the payment transaction 120 to the blockchain and without utilizing blockchain consensus protocols.

It should be appreciated that the computing device 112, like the device 102, may receive blockchain asset data from the secure payment terminal 104 and may store the blockchain asset data as off-chain asset data 320. In some implementations, the computing device 112 may download the blockchain data using the mobile wallet application 310 without interacting with the secure payment terminal 104. Further, it should be understood that the mobile wallet application 310 may utilize secure communications for connecting with other computing devices 112, devices 102, POS payment terminals 118, and the like. Further, the mobile wallet application 310 may use settlement models 548 to validate payment transactions 120. For example, the mobile wallet application 310 may utilize an account settlement model to validate a payment transaction 120 by searching for a transaction ID from the payment transaction 120 in the blockchain. If the payment transaction 120 is validated, the mobile wallet application 310 may adjust a value of the off-chain asset data 320 based on the payment transaction 120.

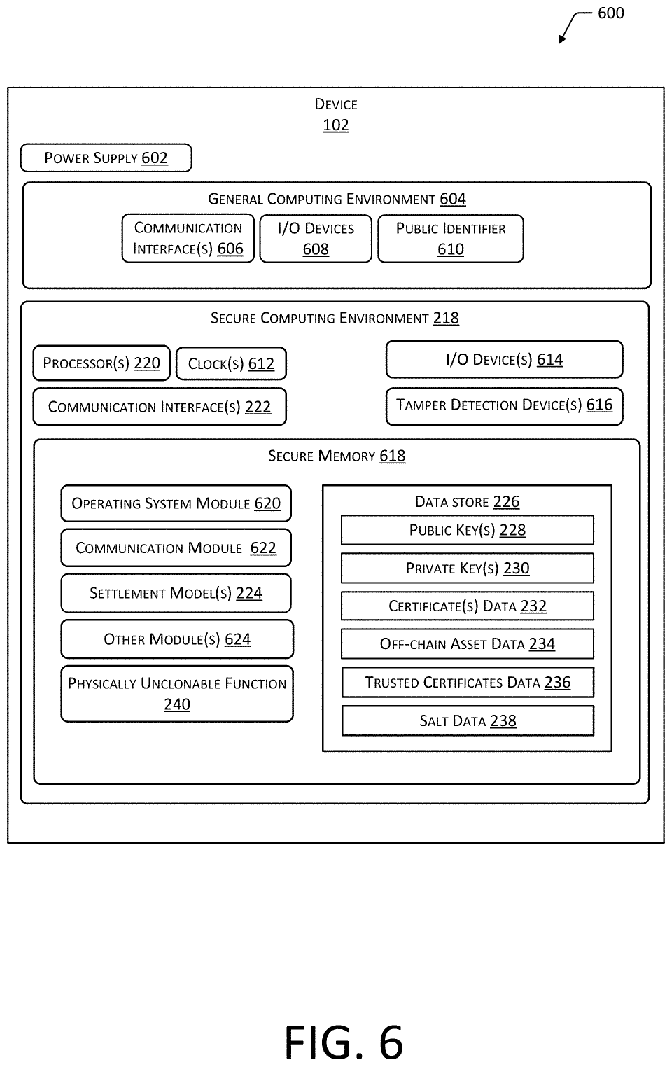

As discussed above, the device 102 may be implemented as a smart card, a wearable device, and so on, or may have another form factor. To enable payment transactions 120, the devices 102 may include hardware and processor-readable instructions that may be used to establish secure communication and to validate payment transactions 120 using the settlement models 224. The device 102 may enforce blockchain rules and utilize the settlement models 224 to enable payment transactions 120 involving off-chain asset data 234 from another device 102 (or off-chain asset data 320 from a computing device 112) without committing the payment transaction 120 to the blockchain and without requiring blockchain consensus protocols. Accordingly, the device 102 may be used to provide a secure, payment transaction 120 through a POS payment terminal 118, such as, for example, a standard point-of-sale (POS) terminal. Such a standard POS payment terminal 118 may include security and secure functionality, but such security and secure functionality may be deemed unsecure as compared to devices that include a secure computing environment such as the device 102, the computing device 112, or the secure payment terminal 104. An example of the device 102 is described below with respect to FIG. 6.

FIG. 6 depicts a block diagram 600 of a device 102, according to one implementation. The device 102 may include a power supply 602, such as a rechargeable battery, a capacitor, or any combination thereof. Further, the device 102 may include hardware components that may communicate data to and receive data from a POS payment terminal 118 or a secure payment terminal 104 and that may establish secure communication with other devices 102, computing devices 112, or any combination thereof.

The device 102 may include a GCE 604, which may include one or more communication interfaces 606, such as an inductive transceiver, a radio-frequency circuit, electrical contacts, or another component through which data may be communicated to and from a POS payment terminal 118 or a secure payment terminal 104. The GCE 604 may further include one or more communication interfaces 606, which may control receiving data and providing data. The GCE 604 may also include one or more input-output (I/O) devices 608, which may electrically or communicatively couple to a device slot 108 of a secure payment terminal 104. Additionally, the GCE 604 may include a public identifier 610, which may be a public key 228 or other indicia that identifies the device 102 as compared to other devices 102. In one possible example, the public identifier 610 may be implemented as or created using a physically unclonable function 240.

The device 102 may further include an SCE 218, which may include one or more hardware processors 220 configured to execute one or more stored instructions. The processor(s) 220 may include one or more cores. One or more clocks 612 may provide information indicative of date, time, ticks, and so forth. For example, the processor(s) 220 may use data from the clock 612 to generate a timestamp, trigger a preprogrammed action, and so forth. The device 102 may include one or more busses or other internal communications hardware or software that allows for the transfer of data between the various modules and components of the device 102.

The device 102 may include one or more communication interfaces 222, which may include one or more input/output (I/O) interfaces to enable the device 102 to communicate with the POS payment terminal 118 or the secure payment terminal 104. The communication interfaces 222 may include interfaces such as Inter-Integrated Circuit (I2C), Serial Peripheral Interface bus (SPI), Universal Serial Bus (USB) as promulgated by the USB Implementers Forum, RS-232, and so forth. In one possible example, the communication interfaces 222 may communicate data between the SCE 218 and the GCE 604. In some implementations, the communication interfaces 222 may include a wireless communication interface to provide wireless communication with the secure payment terminal 104 (or a POS payment terminal 118). For example, the wireless communication interface may support near-field communication (NFC) or other short-range wireless communication.

The SCE 218 may further include one or more input output (I/O) devices 614 to couple the device 102 to the POS payment terminal 118 or the secure payment terminal 104. For example, the communication interfaces 222 may communicate data from the SCE 218 through one or more I/O devices 614 when the device 102 is coupled to a secure payment terminal 104.

Additionally, the SCE 218 may include one or more tamper detection devices 616. The tamper detection devices 616 may be configured to detect probes and to detect tampering with one or more elements of the device 102. In response to detecting such tampering, the tamper detection devices 616 may cause the SCE 218 to shut down. In some implementations, the tamper detection devices 616 may generate a signal that may cause the SCE 218 to delete, alter, or overwrite information stored on a secure memory 618 to prevent theft. For example, the secure memory 618 may include a controller that manages reading data from and writing data to the secure memory 618, which may be a magnetic storage device, a solid-state storage device, and the like. The controller may encrypt data written to the secure memory 618 and may decrypt data read from the secure memory 618 using a private key 230 from the datastore 226. In response to detection of tampering, the controller may overwrite, alter, or delete the private key 230, preventing decryption of data stored within the secure memory 618. Other implementations are also possible.

The secure memory 618 may include an operating system module 620, which may include instructions for operation of the device 102. Further, the secure memory 618 may include one or more communication modules 622 to control operation of the communication interfaces 222. For example, the one or more communication modules 622 may control the communication interfaces 222 to establish secure communications with another device 102 through a POS payment terminal 118.

The secure memory 618 may also include a plurality of settlement models 224. Each of the settlement models 224 may define a set of rules for validating a payment transaction 120 of a particular type. For example, a first settlement model may be used for Bitcoin transactions, a second settlement model may be used for Ethereum transactions, while a third is used for UTXO transactions, and so on. In some implementations, the settlement models 224 may be selected based on the content of a payment transaction 120. For example, instead of or in addition to settlement models 224 that are specific to a type of cryptocurrency, some of the settlement models 224 may be selected based on the data included within the payment transaction, such as the type of validating information (transaction ID, private key, stochastic proof, and so on). The device 102 may use the settlement models 224 to validate payment transactions 120 and to enforce blockchain rules in the handling of the payment transaction 120.

For example, the processor 220 may determine one of a settlement models 224 in response to receiving payment information. The particular settlement model 224 may be selected based on the type of digital currency payment. For example, a Bitcoin transaction may cause the processor 220 to select a first settlement model 224. In another example, an Ethereum transaction may cause the processor 220 to select a second settlement model 224. The selected settlement model 224 may identify the particular blockchain asset in the blockchain, rules for validating the off-chain asset data, and rules for validating a payment transaction that enforces the blockchain rules for the particular type of cryptocurrency.

The processor 220 may use the selected settlement model 224 to validate the payment transaction 120. For example, a first settlement model 224 may cause the processor 220 to search a blockchain based on a particular transaction identifier (ID) to determine a blockchain asset associated with the transaction ID. In another example, a second settlement model 224 may cause the processor 220 to validate a proof associated with the payment transaction 120 against a blockchain model of the stochastic settlement models 224. Other implementations are also possible.

Depending on the validation process determined from the selected settlement model 224, the device 102 may accept or decline the payment transaction 120. For example, in response to receiving a payment transaction 120 including a transaction ID, the processor 220 may utilize the communication interfaces 222 to search the blockchain data 404 for the transaction ID to determine if a digital asset on the blockchain data 204 has a value that is greater than the payment amount in the payment transaction 120. If the blockchain asset value is greater than the payment amount, the device 102 may accept the payment transaction 120 and may adjust a value of the off-chain asset data 234 based on the payment amount. Other implementations are also possible.

Further, the secure memory 618 may include other modules 624 to perform various functions. Additionally, the secure memory 618 may include a physically unclonable function (PUF) 240, which may be used to generate a private key 230 or which may be used as the private key 230. In some implementations, the PUF 240 may be used to produce one or more public-private key pairs of public keys228 and private keys 230. Alternately, the PUF 240 may be used as input into an encryption process which is used to store public-private key pairs, which are generated without the interaction of the PUF 240, in an encrypted state. Other implementations are also possible.

The secure memory 618 may also include a data store 226 including public keys 228, private keys 230, and certificates data 232. The data store 226 may also include off-chain asset data 234. Additionally, the data store 226 may include a list of trusted certificate issuers data 236, which may be accessed to verify a digital asset loading authority or a manufacturer based on its signed public key or certificate. The data store 226 may also include salt data 238 (random or pseudo random data), which may be used, together with the public keys 228 to establish secure communication with a second device 102. Other implementations are also possible.

The device 102 may be configured to manage its own secure communications and to validate payment transactions 120 involving off-chain asset data 234 received from other devices 102 or from the computing device 112. As discussed above, the device 102 may resolve a received payment transaction 120, determining whether or not to accept payment, using a selected settlement model 224 of a plurality of settlement models 224.

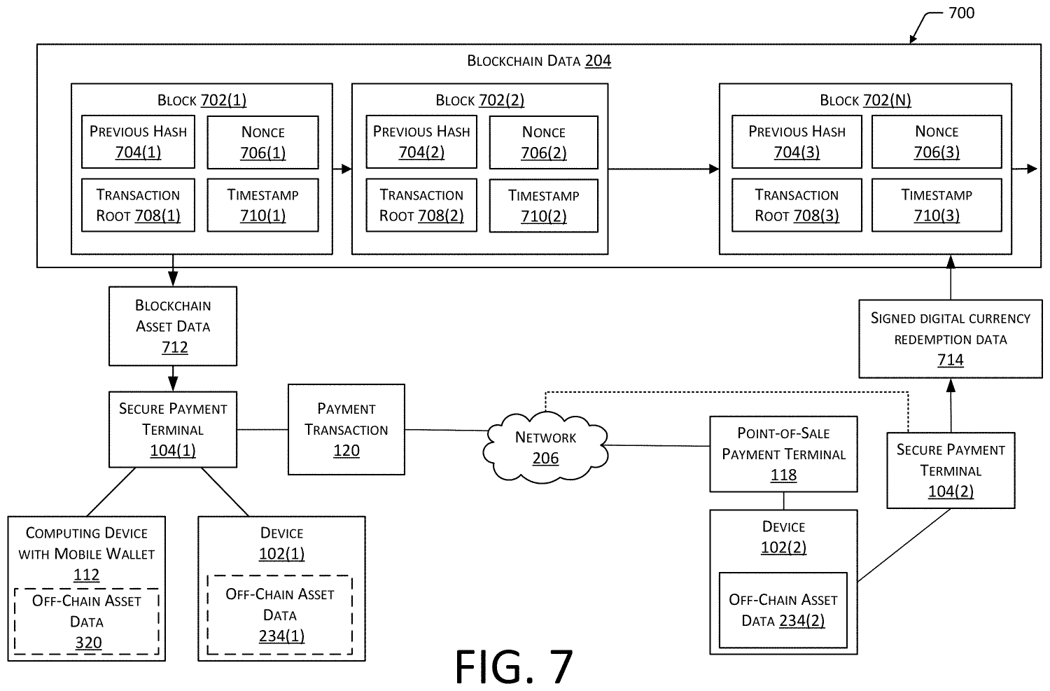

FIG. 7 illustrates blockchain data 204, download of blockchain asset data 712 for storage in a device 102 as off-chain asset data 234, transfer of off-chain asset data 234 between devices 102, and redemption of off-chain asset data 234 to the blockchain according to one possible implementation. A distributed ledger or blockchain comprises a system that utilizes a network of peers (one or more blockchain servers 202) that provide distributed data storage and processing of blockchain data 204. The blockchain data 204 provides a canonical record of transactions. The blockchain data 204 maintains information about a current state as well as how that current state was arrived at. The blockchain data 204 includes a plurality of blocks 702. The block 702(2) in the blockchain includes blockchain asset data and information about the block 702(1), which is the previous block in the blockchain.

To maintain a deterministic state at all times, data is recorded into the distributed blockchain data 204 in blocks 702(1), 702(2), . . . , 702(N). Each block 702 comprises a block header that includes a previous hash 704, a nonce 706, a transaction root 708, and a timestamp 710. The block 702 may include payload data, such as details of a transaction 120, contract parameters, and so forth. In some implementations the block 702 may include other data that facilitates proof and verification of the transactions 120 that are contained in that block 702 as well as the precedence of the existence of that block 702 relative to other blocks 702 in the blockchain data 204. Blocks 702 are linked together over time by recording the previous hash 704 of the previous block 702 in the subsequent block 702. For example, block 702(2) includes the previous hash 704(2) that is derived from the data in the block 702(1). The previous hash 704 of a given block may be constructed of a hash of data contained in the block 702 as well as a nonce 706 which forms a block hash which meets the requirements of consensus of the given blockchain. Multiple blockchain assets may be committed within each block 702.

The secure payment terminal 104(1) may be used to download blockchain asset data 712, which may have a cryptocurrency value that may represent a complete blockchain asset or a portion of a blockchain asset in the blockchain data 204. During this process, the secure payment terminal 104(1) may send a secure, signed message to the one or more blockchain servers 202 to extract blockchain asset data 712 from the blockchain data 204, causing the one or more blockchain servers 202 to provide a transaction ID confirming the transaction 120 as part of the downloaded digital asset and to update the blockchain data 204 to reflect the transaction. The blockchain servers 202 may mark or encumber the blockchain asset, typically by the public key 228 and private key 230 pair (public-private key pair) stored on the device 102, within the blockchain to indicate that the blockchain asset is encumbered so that it cannot be double spent.

The secure payment terminal 104(1) may provide the blockchain asset data 712 to the computing device 112, which may store the blockchain asset data 712 in the secure memory 540 as off-chain asset data 320. Alternatively, the secure payment terminal 104(1) may provide the blockchain asset data 712 to the device 102(1), which may store the blockchain asset data 712 in the secure memory 618 as off-chain asset 234(1). Subsequently, the computing device 112 or the device 102(1) may conduct a cryptocurrency transaction with another device, such as another device 102(2).

For example, the device 102(1) may be coupled to the secure payment terminal 104(1) or to a POS payment terminal 118. The device 102(1) may establish (through the coupled secure payment terminal 104(1)), secure communication with the device 102(2). Establishing secure communications may include exchanging public keys 228 and salt data 238 (random or pseudo random data provided by one of the devices 102) and verifying the exchanged data. The device 102(1) may establish a trust relationship with the device 102(2) by exchanging its certificate data 232(1) which is its public key 228(1) signed by a manufacturer and which may be verified to establish the trust relationship.

Once the secure communications and the trust relationship are established, the device 102(1) may generate a payment transaction 120 including a portion of the off-chain asset data 234(1) and may send the payment transaction 120 to the device 102(2).

Upon generation of the payment transaction 120, the device 102(1) may adjust a value of the off-chain asset data 234(1) according to the payment information included in the payment transaction 120. For example, if the payment transaction 120 includes a Bitcoin, the device 102(1) may adjust a value of the off-chain asset data 234(1) by one bitcoin.

The device 102(1) may send the payment transaction 120 via the secure payment terminal 104(1) through the network 206 to a POS payment terminal 118 (or optionally to another secure payment terminal 104(2)). The payment transaction 120 may include payment information (such as a portion of off-chain asset data 234) as well as information that may be used to validate the authenticity of the payment information using a selected settlement model 224.

The device 102(2) may receive the payment transaction 120 via the POS payment terminal 118 (or optionally via the secure payment terminal 104(2)). The device 102(2) may determine one of the settlement models 224 and may use the settlement model 224 to validate the payment transaction 120. If the payment transaction 120 cannot be validated using the information and the selected settlement model 224, the device 102(2) may refuse the payment transaction 120. Otherwise, the device 102(2) may accept the payment transaction 120 and adjust a value of the off-chain asset data 234(2) in the data store 226(2) within the secure memory 618(2). Continuing the example, the payment transaction 120 includes a bitcoin from the off-chain asset data 234(1). After the device 102(2) validates the payment transaction 120, the device 102(2) adjusts a value of the off-chain asset data 234(2) by one bitcoin.

It should be understood that the example of a payment transaction 120 involving a single bitcoin is provided for illustrative purposes only, and is not intended to be limiting. Other cryptocurrencies and other amounts may be transferred in a payment transaction 120.

Subsequently, the device 102(2) may be coupled to a secure payment terminal 104(2), which may be used to generate signed digital currency redemption data 714, which may be sent by the secure payment terminal 104(2) to the one or more blockchain servers 202 to commit a portion of the off-chain asset data 234(2) to the blockchain data 204. For example, a portion of the off-chain asset data 234(2) may be included in a blockchain transaction, signed by the private key 230 of the device 102(2) and may be sent to one or more blockchain servers 202 to be committed to the blockchain. In this example, the signed digital currency redemption data 714 may be incorporated into the blockchain data 204, such as into the block 702(N). Other implementations are also possible.

In the illustrated example, time passed between a first time when the blockchain asset data 712 was downloaded and stored as off-chain asset data 234(2) within the device 102(2) and a second time when the device 102(2) committed the portion of the off-chain asset data 234(2) to the blockchain via the signed digital currency redemption data 714. Between the first time and the second time, multiple blocks 700 were added to the blockchain, so the signed digital currency redemption data 714 may be committed in block 702(N).

It should be understood that the device 102(2) may be used to conduct other payment transactions 120, which may increase or decrease the value of the off-chain asset data 234(2), before committing the portion of the off-chain asset data 234(2) to the blockchain. Further, the device 102(1) may also be used to conduct other payment transactions 120, before committing the off-chain asset data 234(1) to the blockchain. Additionally, the assets transferred to the device 102(2) from the device 102(1) off-chain may be used to transfer funds from device 102(2) to other devices 102. There is no limit to the number of devices 102 that may receive and subsequently send an off-chain asset prior to redeeming to the blockchain. Other implementations are also possible.

The device 102 may be configured to manage settlement of payment transactions 120, such as the payment transaction 120, off-chain (without committing the payment transaction to the blockchain and without using blockchain consensus protocols). Though the devices 102 may query the blockchain and may communicate through the network 206, the device 102(2) resolves the payment transaction 120 off-line because the validation and acceptance may be performed without committing the payment transaction 120 to the blockchain. This allows a user 106 of the device 102(2) to aggregate multiple payment transactions 120, adjusting a value of the off-chain asset data 234(2) with each transaction, and to commit a portion (some or all) the off-chain asset data 234(2) to the blockchain in a single transaction.

In the illustrated example, the device 102(2) is coupled to the network 206 through the POS payment terminal 118 to receive the payment transaction 120. In another implementation, the device 102(2) may receive the payment transaction 120 through the secure payment terminal 104(2), as indicated by the dotted line. Other implementations are also possible.

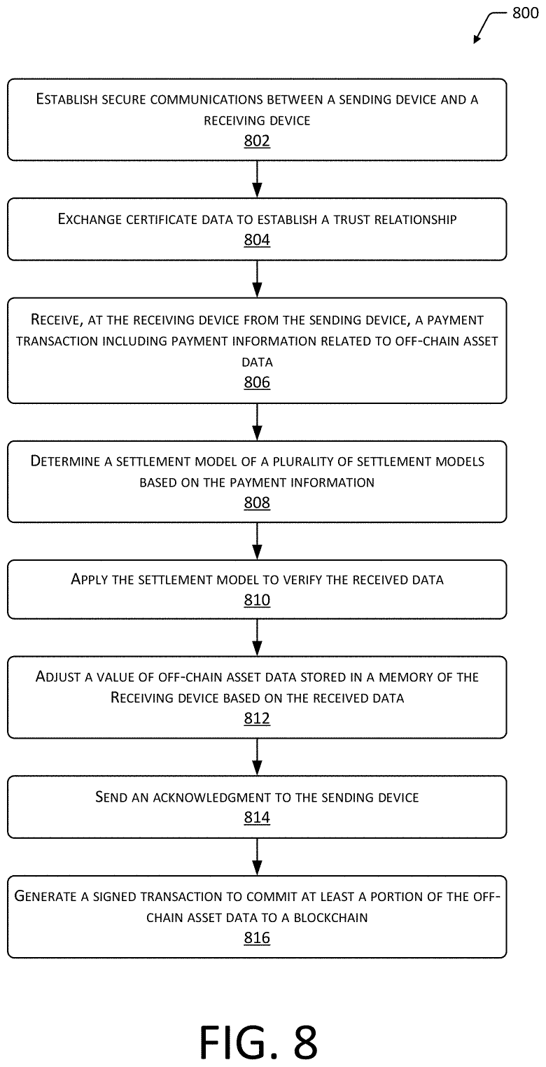

FIG. 8 depicts a flow diagram 800 of a process of conducting an off-chain asset data transaction between devices, according to one implementation. At 802, secure communications are established between a sending device 102(1) and a receiving device 102(2). For example, the sending device 102(1) may establish secure communication with the receiving device 102(2) through the POS payment terminal 118(1) or through the POS payment terminals 118(1) and 118(2). The sending device 102(1) may send its public key 228(1) to the receiving device 102(2). In response, the receiving device 102(2) may encrypt its public key 228(2) and salt data 238(2) to form encrypted data using the public key 228(1) and may send the encrypted data to the sending device 102(1). The sending device 102(1) may receive and decrypt the public key 228(2) and the salt data 238(2) using the public key 228(1). The sending device 102(1) may encrypt the salt data 238(2) with the public key 228(2) to form encrypted data. The sending device 102(1) may then send the encrypted data to the receiving device 102(2). The receiving device 102(2) may decrypt the encrypted data and verify that the salt data 238(2) is correct. If the salt data 238(2) is correct, the sending device 102(1) and the receiving device 102(2) have established secure communication, and all further communications between the sending device 102(1) and the receiving device 102(2) may be encrypted before transmission.

At 804, one or more of the devices' certificates data 232 may be exchanged to establish a trust relationship. In some implementations, once the secure communication is established, the sending device 102(1) and the receiving 102(2) may exchange additional data to authenticate one another. For example, the sending device 102(1) may send to the receiving device 102(2) data which is encrypted using the public key 228(2) corresponding to the provided certificate data 232(2). The data may include random data, pseudorandom data, other data, or any combination thereof. The certificate data 232(2) was previously digitally signed by a manufacturer of one of the components of the receiving device 102(2). In response to receiving the encrypted data, the device 102(2) may decrypt the data to determine the data encrypted using the public key 228(2) contained in the certificate data 232(2). The receiving device 102(2) may then encrypt the data using the public key 228(1) corresponding to the certificate data 232(1) provided by the sending device 102(1) and may send the result back to the sending device 102(1). The sending device 102(1) may then decrypt the data and compare it to the data originally sent to the receiving device 102(2). This allows the sending device 102(1) to ascertain that the receiving device 102(2) has the private key 230(2) corresponding to the public key 228(2) contained in the previously provided certificate data 232(2). Additionally, the sending device 102(1) may use the certificate data 232(2) to search a local list of trusted certificates issuers data 236(1), which may include public keys of one or more trusted entities, such as the manufacturer of the receiving device 102(2). The list of trusted certificates data 236(1) may be stored in the data store 226(1) and may be used to establish a trust relationship. In an example, a list of trusted certificates data 236(1) may be stored in the data store 226(1) and, if the manufacturer associated with the certificate data 232(2) is included in the list, the sending device 102(1) may verify the certificate data 232(2) presented by the receiving device 102(2) using the corresponding certificate data 232(2). In response to verifying the certificate data 232(2), the sending device 102(1) may send encrypted data to the receiving device 102(2) that includes an acknowledgement that the receiving device 102(2) has acceptable provenance based on its certificate data 232(2).

Additionally, the receiving device 102(2) may send encrypted data including its certificate 232(2). For example, the receiving device 102(2) may send to the sending device 102(1) data which is encrypted using the public key 228(1) corresponding to the provided certificate data 232(1). The certificate data 232(1) was previously digitally signed by a manufacturer of one of the components of the sending device 102(1). In response to receiving the encrypted data, the sending device 102(1) may decrypt the data to determine the challenge data encrypted using the public key 228(1) corresponding to certificate data 232(1). The receiving device 102(1) may then encrypt the data using the public key 228(2) corresponding to the certificate data 232(2) provided by the device 102(2) and may send the result back to the receiving device 102(2). The receiving device 102(2) may then decrypt the data and compare it to the data originally sent to the sending device 102(1). This allows the receiving device 102(2) to ascertain that the sending device 102(1) has the private key 230(1) corresponding to the public key 228(1) contained in the previously provided certificate data 232(1). Additionally, the receiving device 102(2) may use the certificate data 232(1) to search a local list of trusted certificates data 236(2), which may include public keys of one or more trusted entities. The list of trusted certificates issuers data 236(2) may be stored in the data store 226(2) and may be used to establish a trust relationship. In an example, a list of trusted certificates data 236(2) may be stored in the data store 226(2) and, if the manufacturer associated with the certificate data 232(1) is included in the list, the receiving device 102(2) may verify the certificate data 232(1) presented by the sending device 102(1) using the corresponding certificate data 232(1). In response to verifying the certificate data 232(1), the receiving device 102(2) may send encrypted data to the sending device 102(1) that includes an acknowledgement that the receiving device 102(2) has acceptable provenance based on its certificate data 232(1).

At 806, a payment transaction 120 including payment information may be received at the receiving device 102(2) from the sending device 102(1). For example, the receiving device 102(2) may receive a payment transaction 120 from the sending device 102(1). The payment transaction 120 may include payment information that relates to a portion of off-chain asset data 234(1) and associated information, which may be used by the receiving device 102(2) in conjunction with a determined one of the settlement models 224(2) to validate the payment transaction 120.

At 808, a settlement model 224 of a plurality of settlement models 224 may be determined based on the payment information. For example, the receiving device 102(2) may determine a settlement model 224 of the plurality of settlement models 224(2) to validate and complete the payment transaction 120. The settlement model 224 may be determined based on the information included within the payment transaction 120. For example, if the payment transaction 120 includes a stochastic proof, the receiving device 102(2) may utilize a stochastic settlement model. In another example, if the payment transaction includes a transaction ID, the receiving device 102(2) may use an account settlement model. Assuming that one of the settlement models 224(1) is selected, the receiving device 102(2) may determine appropriate information provided by the device 102(2) to allow the receiving device 102(2) to verify the off-chain asset data 234 being used for settlement based on the rules and methods defined by the selected settlement model 224.

At 810, the settlement model 224 may be applied to verify the received data. The one or more settlement models 224 may include various sets of rules and processes that may be implemented to enable transactions without committing the payment transaction 120 to the blockchain and without requiring commonly used consensus protocols. The settlement models 224 may be used, off-chain, by the device 102 to validate payment transactions 120. The settlement models 224 may include, but are not limited to, a key settlement model, a UTXO settlement model, an account settlement model, an authority settlement model, a stochastic settlement model, other settlement models, or any combination thereof. In an example, the selected settlement model 224 may define rules and processes for validating the payment transaction 120 from the received data and for managing the off-chain asset data 234 according to blockchain rules based on acceptance or refusal of the payment transaction 120. It should be appreciated that the off-chain asset data 234(1) in the secure memory 618(1) of the sending device 102(1) may be adjusted based on the payment transaction 120. For example, the sending device 102(1) may adjust the off-chain asset data 234(1) when the payment transaction 120 is sent.

At 812, off-chain asset data 234(2) stored in a secure memory 618(2) of the receiving device 102(2) may be adjusted based on the payment transaction 120. For example, the receiving device 102(2) may adjust a value of the off-chain asset data 234(2) in the secure memory 618(2) based on the validated payment transaction 120. In an example where the sending device 102(1) is sending a payment to the receiving device 102(2), the sending device 102(1) may adjust a value of the off-chain asset data 234(1) based on the payment. Additionally, the receiving device 102(2) may adjust the value the off-chain asset data 234(2) based on the payment transaction 120.

At 814, an acknowledgment may be sent to the sending device 102(1). For example, the receiving device 102(2) may send an acknowledgment indicative of acceptance of the payment transaction 120 and other data to the sending device 102(1).

At 816, a signed transaction may be generated to redeem at least a portion of the off-chain asset data to the blockchain. For example, the receiving device 102(2) may be coupled to a secure payment terminal 104. The user 106(2) may then interact with the touchscreen 110 of the secure payment terminal 104 or may interact with the touchscreen 110 of the computing device 112 to initiate a redemption operation to redeem at least some of the off-chain asset data 234(2) to the blockchain. A digitally signed message may be generated that includes a portion of the off-chain asset data 234(2) and the digitally signed message is sent to one or more of the blockchain servers 202 to commit the portion to the blockchain. Other implementations are also possible.

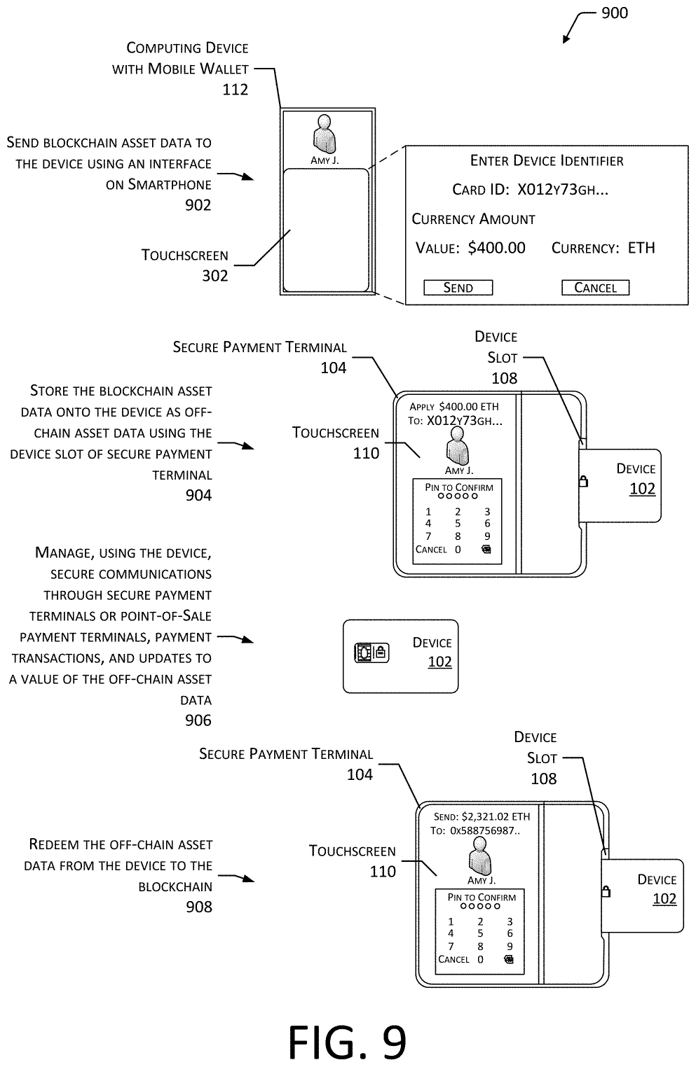

FIG. 9 depicts a diagram 900 of a process of storing and redeeming digital currency value onto a device 102, according to one implementation. At 902, blockchain asset data 712 may be sent to a device 102 using an interface on a touchscreen 302 of the computing device 112. In one possible example, a user 106 may interact with the touchscreen 302 of the computing device 112 to initiate a transfer of blockchain asset data 712 from the blockchain to the device 102. The graphical interface displayed on the touchscreen 302 of the computing device 112 may include a plurality of fields or user-selectable elements accessible by the user 106 to specify a unique identifier of a device 102, a currency amount, a currency type, other information, or any combination thereof. The user 106 may then select a “send” button to initiate a download operation via the secure payment terminal 104.

At 904, the blockchain asset data may be stored onto the device 102 using the device slot 108 of the secure payment terminal 104. In this example, in response to sending the value to the device 102, the secure payment terminal 104 may receive data from the computing device 112 and may present a graphical interface on the touchscreen 110. The graphical interface may include a plurality of soft buttons that may be selected by the user 106 to confirm transfer of the blockchain asset data 712 to a device 102 inserted in one of the device slots 108. If the user 106 enters a pin or other information indicative of his or her authorization to transfer the blockchain asset data 712, the secure payment terminal 104(1) may communicate with the one or more blockchain servers 202 to download the blockchain asset data 712 from the blockchain data 204 and to store the blockchain asset data 712, an associated transaction ID, a timestamp, other information, or any combination thereof on the device 102, which stores the data as off-chain asset data 234.

At 906, the device 102 manages secure communications through secure payment terminals 104 or POS payment terminals 118, payment transactions 120, and updates to the off-chain asset data 712. As discussed above, the device 102 may manage exchange of keys and other identifying information to establish secure communications and a trust relationship and may use settlement models 224 to validate and complete payment transactions 120, without committing the payment transactions 120 to the blockchain and without blockchain consensus protocols. Instead, the device 102 validates and manages payment transactions 120off-chain according to determined settlement models 224.

At 908, the off-chain asset data 234 from the device 102 may be redeemed to the blockchain. For example, the device 102 may be inserted into a device slot 108 of the secure payment terminal 104, and the user 106 may interact with the touchscreen 110 to initiate a redemption operation to commit the off-chain asset data from the device 102 to the blockchain by sending a signed message to the one or more blockchain servers 202.

While the device 102 is depicted as having a card-type form factor, the device 102 may take other forms. In some implementations, the device 102 may be a wearable device.

It should be understood that the device 102 may be used for multiple payment transactions 120. Each transaction may be managed using the same or a different settlement model 224, and off-chain asset data 234 may be updated (increased or decreased) with each payment transaction 120. In some implementations, the device 102 may receive payment transactions 120 in different forms of cryptocurrency (such as Ethereum, Bitcoin, and so on). The off-chain asset data 234 may include multiple balances, each of which may be associated with a different cryptocurrency. The redemption of the off-chain asset data 234 to the blockchain may be performed in multiple transactions, one for each type of currency. Further, multiple transactions of the same currency type may be aggregated and then redeemed to the blockchain in a single transaction. Other implementations are also possible.

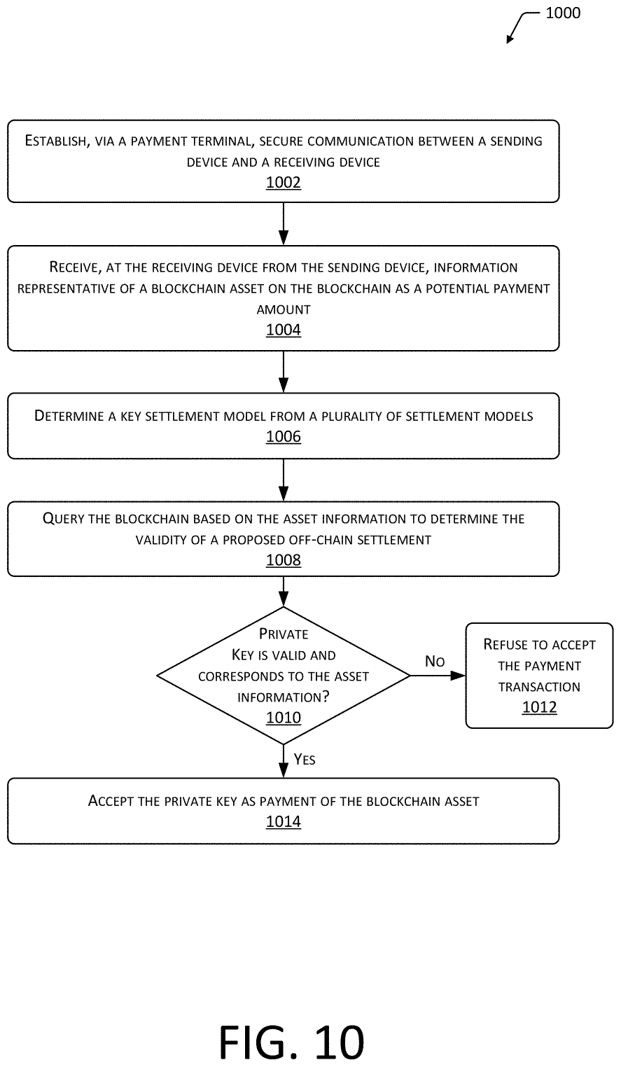

FIG. 10 depicts a flow diagram 1000 of a process of conducting an off-chain digital currency transaction between devices 102 using a key-based settlement model, according to one implementation. At 1002, secure communication between a first device 102(1) and a second device 102(2) may be established via a payment terminal. The payment terminal may be a secure payment terminal 104 or a POS payment terminal 118. The secure communication may be established by exchanging public keys 228, certificates data 232, salt data 238, other data, or any combination thereof.

At 1004, information representative of a blockchain asset in the blockchain may be received, at the second (receiving) device 102(2), as a potential payment amount from the first (sending) device 102(1). The type of information used to represent payment may be resolved using a key settlement model of the settlement models 224.

At 1006, a key settlement model may be determined from the plurality of settlement models 224. Within the key settlement model, the private key 230 that is used to sign transactions may be used to represent the blockchain assets on the blockchain. For example, using the key settlement model, the sending device 102(1) may pass a private key 230(1) to a receiving device 102(2). The receiving device 102(2) may accept the private key 230 as payment by using the selected key settlement model from the settlement models 224(2) to check a blockchain asset in the blockchain data 204 that corresponds to the private key 230(1). Based on the selected key settlement model of the plurality of settlement models 224(2), the receiving device 102(2) may trust that the sending device 102(1) will permanently delete the private key 230(1) that is passed and that no other copy of that private key 230(1) exists. The private key 230(1) itself thus may become the bearer asset, and possession of the private key 230(1) constitutes possession of the blockchain asset.

At 1008, the blockchain is queried based on the asset information to determine validity of a proposed off-chain settlement. In particular, the receiving device 102(2) may query the blockchain data 204 to determine if the asset corresponding the public key 228(1) exists and to verify that a blockchain asset in the blockchain on which the receiving device 102(2) is willing to settle. If the receiving device 102(2) decides to accept the indicated asset as settlement, the sending device 102(1) will send the associated private key 230(1) to the receiving device 102(2). The receiving device 102(2) may be able to determine the private key 230(1) is valid by deriving the public key 228(1) associated with the private key 230(1) and ensuring that it is the public key 228(1) associated with the previously described blockchain asset. The receiving device 102(2) would then provide confirmation to the sending device 102(1) that the transaction is successful. Additionally, the receiving device 102(2) may also provide a confirmation of a successful transaction to the user. In this example, the private key 230 corresponding to the blockchain asset may be transferred as a “bearer asset”, such that the holder of the private key 230 becomes the owner of the blockchain asset.

At 1010, if the private key 230(1) is not valid (i.e. is not associated with the blockchain asset corresponding to the payment information) and/or does not correspond to the asset information, the payment transaction 120 may be refused, at 1012. For example, the receiving device 102(2) may send a query including data associated with the blockchain asset to the one or more blockchain servers 202. One or more of the blockchain servers 202 may search the blockchain to find a blockchain asset that corresponds to the blockchain asset. If the one or more blockchain servers 202 identify a blockchain asset that corresponds to the asset information, the one or more blockchain servers 202 may send, to the receiving device 102(2), data including a blockchain address associated with the blockchain asset, a time stamp, a date stamp, an asset type (such as Bitcoin, UTXO, Ethereum, and so on), an asset value, other data, or any combination thereof. The receiving device 102(2) may receive the data from the one or more blockchain servers 202. If the received data indicates that the blockchain servers 202 did not find the blockchain asset in the blockchain or if the value associated with the blockchain asset is insufficient or different from the payment information in the signed message from the sending device 102(1), the private key 230(1) is not valid, and the receiving device 102(2) may refuse to accept the payment transaction 120.

Otherwise, at 1010, if the private key 230(1) is valid and corresponds to the indicated asset information, the private key 230(1) may be accepted as payment of the blockchain asset, at 1014. For example, if the private key 230(1) matches an asset on the blockchain and the payment amount is equal to the asset value, the receiving device 102(2) may accept the private key 230(1) as payment. The private key 230(1) in this example is a bearer asset, such that possession of the private key 230(1) equals ownership of the blockchain asset. Other implementations are also possible.

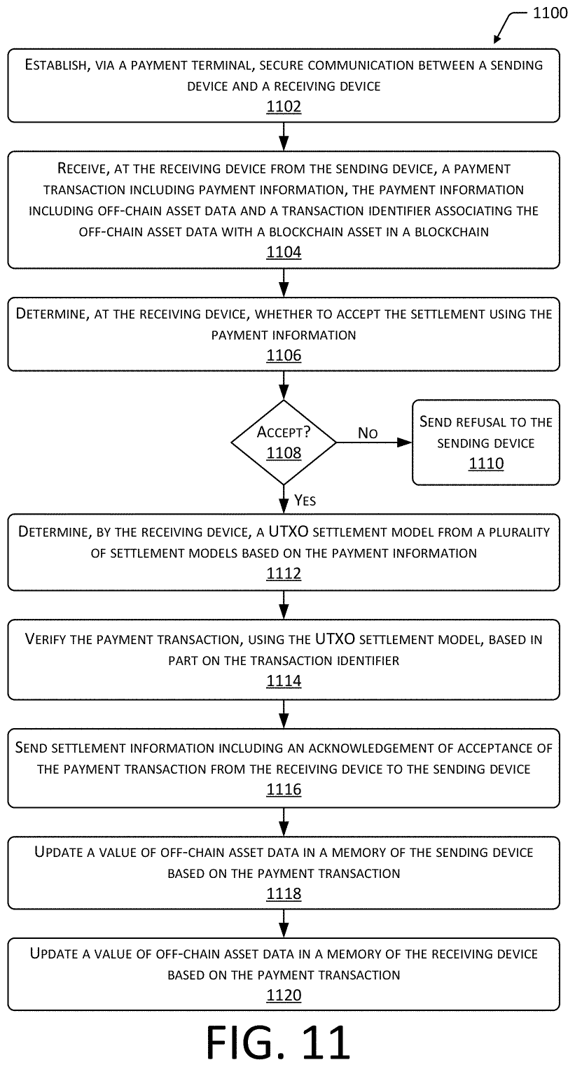

FIG. 11 depicts a flow diagram of a process of conducting an off-chain digital currency transaction between devices 102 using an unspent transaction output (UTXO) settlement model, according to one implementation. In an example, in the UTXO settlement model, the user 106 may utilize a secure payment terminal 104 or a computing device 112 in conjunction with the secure payment terminal 104 to make an on-chain transaction to a public key 228 of a device 102(1), and the device 102(1) may receive a transaction ID and transaction details, which may be stored as off-chain asset data 234(1) on the device 102(1).

At 1102, secure communication between a sending device 102(1) and a receiving device 102(2) may be established via a payment terminal. The payment terminal may be a secure payment terminal 104 or a POS payment terminal 118. The secure communication may be established by exchanging public keys 228, certificates data 232, salt data 238, other data, or any combination thereof.

At 1104, a payment transaction 120 including payment information may be received, at the receiving device 102(2) from the sending device 102(1), and the payment information may include off-chain asset data and a transaction identifier associating the off-chain asset data with a blockchain asset in a blockchain. For example, in the UTXO settlement model, the sending device 102(1) may encumber unspent blockchain assets or funds of the blockchain data 204 to produce an unspent transaction output (UTXO), which encumbers the blockchain assets with a hash which requires the presentation of a pre-image to move funds. Alternatively, the assets may be encumbered using a cryptographic accumulator which is a type of hash function that requires the presentation of one or more sets of data which are members to the cryptographic accumulator. The UTXO may represent an input to a new transaction that results from unspent output of a previous transaction. In some implementations, the UTXO may be subdivided on the sending device 102(1) without interacting with the blockchain by spending subsets of the cryptographic accumulator which encumbers the asset. The UTXO may then be sent, together with a transaction identifier and other information, as a payment transaction 120 to the receiving device 102(2).

At 1106, the receiving device 102(2) may determine whether to accept the settlement using the payment information. For example, the receiving device 102(2) may determine that a particular payment type is not acceptable based on one or more settings associated with the receiving device 102(2).

At 1108, if the payment information is not accepted, the method may include sending a refusal to the sending device 102(1), at 1110. For example, the receiving device 102(2) may send a message to the sending device 102(1) indicating that the payment was not accepted.

Otherwise, at 1108, if the payment information is accepted, the method may include determining a UTXO settlement model from a plurality of settlement models 224(2) by the receiving device 102(2), based on the payment information, at 1112. In particular, the sending device 102(1) may send the UTXO, transaction data, and associated data (such as pre-image hash, and private key) to the receiving device 102(2). The receiving device 102(2) may decrypt the payment transaction 120, determine the payment type from the decrypted payment information, and determine the UTXO settlement model based on the payment type.

At 1114, the payment transaction 120 may be verified based in part on the transaction identifier using the UTXO settlement model. For example, the receiving device 102(2) may validate the payment transaction 120 by confirming that the UTXO from an underlying blockchain asset, which has funds sufficient to cover the payment transaction 120. In an example, the receiving device 102(2) may send a query including data identifying the UTXO to the one or more blockchain servers 202. The one or more blockchain servers 202 may utilize the data to determine whether the UTXO remains unspent and is available in the blockchain. The one or more blockchain servers 202 may send, to the receiving device 102(2), data including information about the blockchain asset including date information, time information, an amount of the blockchain asset, other information, or any combination thereof. The receiving device 102(2) may utilize the received data to verify the UTXO based on the received data.

At 1116, the settlement information including an acknowledgment of acceptance of the payment transaction 120 may be sent from the receiving device 102(2) to the sending device 102(1). For example, upon validation, the receiving device 102(2) may send a message confirming acceptance.

At 1118, the sending device 102(1) may update a value of off-chain asset data 234(1) in the secure memory 618 based on the payment transaction 120. For example, the sending device 102(1) may update the off-chain asset data by removing the traded asset from its memory. In some implementations, the sending device 102(1) may change the value of the off-chain asset data 234(1) once the payment transaction 120 is accepted. In other implementations, the sending device 102(1) may change the value of the off-chain asset data 234(1) when the payment transaction 120 is sent. Other implementations are also possible. At 1120, the receiving device 102(2) may update a value of off-chain data in a memory based on the payment transaction. Subsequently, to redeem the value of the UTXO to the blockchain using the receiving device 102(2), the receiving device 102(2) may be coupled to a secure payment terminal 104. The user 106 may interact with the secure payment terminal 104 to initiate a redemption operation, which may cause the secure payment terminal 104 (or a computing device 112 coupled to the secure payment terminal 104) to broadcast a transaction which consumes one or more UTXOs to the one or more blockchain servers 202 by creating a redemption transaction (signed message) redeeming the off-chain asset data 234(2) comprising the UTXO to the blockchain.

In the example of the UTXO settlement model of FIG. 11, if the user 106 wants to spend the UTXO (or a portion thereof) as off-chain asset data 234 prior to redeeming the UTXO to the blockchain, the UTXO (and corresponding data required to form a transaction which meets the UTXO encumbrance, such as a private key, script, hash, and/or hash pre-image) may be presented as a bearer asset to another device 102, without interacting with the blockchain. The receiving device 102 may verify that the UTXO is redeemable on-chain (meaning that the UTXO has not yet been spent and redeemed to the blockchain) and may accept the UTXO and associated data as a payment. In the context of devices 102, the UTXOs may be thought of as analogous to paper currency. In an example where multiple transactions are performed before redemption to the blockchain, intervening transaction details may be lost. For example, when the UTXO funds are redeemed, the original source address of the UTXO funds will be known from the preimage hash, but intermediary fund holders will not be known and will not be included in the blockchain data 204.

Typically, the UTXO will have a non-trivial value, and each UTXO may be redeemed in an individually processed and verified transaction when redeeming the UTXO to the blockchain data 204. UTXOs could be redeemed more efficiently by creating a redemption transaction which redeems multiple UTXOs in one transaction. However, although the cost per UTXO redemption decreases as more UTXOs are atomically included in a single transaction, the cost logarithmically approaches a lower limit. One possible advantage of UTXO-based asset trading is that a device 102 may leverage the cryptographic accumulator to subdivide the UTXOs as needed. Also, a receiving device 102 that receives a UTXO may verify that the UTXO is redeemable by making a simple read query to the blockchain data 204.

If the device 102 is hacked, lost, or compromised, the potential loss is localized to the value of a single UTXO. Since a non-trivial fee may be assessed when redeeming the UTXO to the blockchain data 204, each UTXO may have a non-trivial value, which sets a lower limit on the value of a UTXO which will be practical. For example, if a current processing fee for a transaction is $0.05 and a UTXO is worth one dollar, that may make sense for some users 106. However, if the UTXO was worth $0.10 and the transaction fee is $0.05, the transaction fee becomes a significant portion of the UTXO value, making the UTXO transaction less practical.

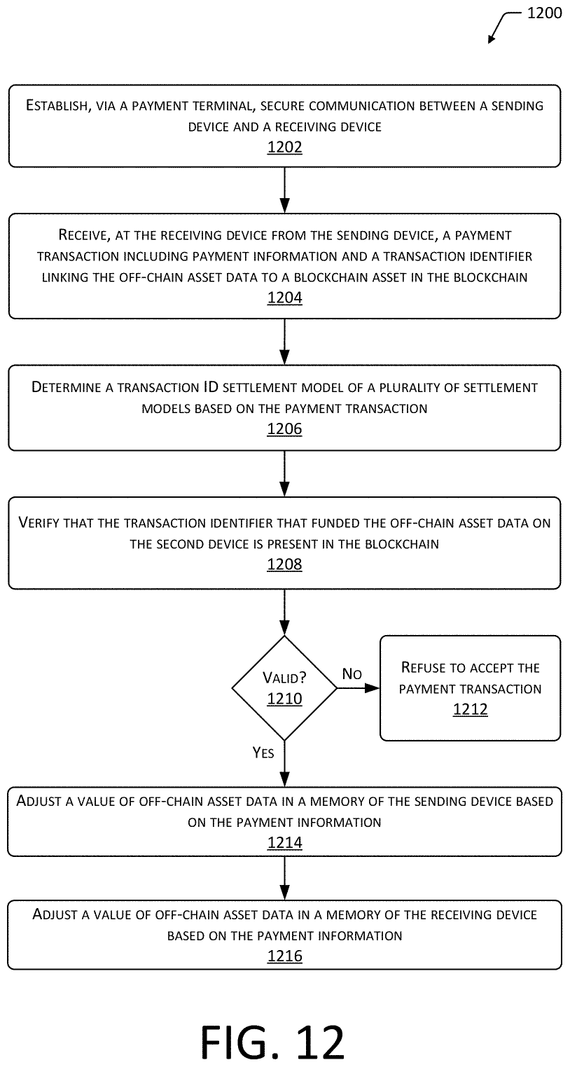

FIG. 12 depicts a flow diagram 1200 of a process of conducting an off-chain digital currency transaction between devices 102 using an account settlement model, according to one implementation. In the account settlement model, a device 102 may be loaded with blockchain asset data from a transaction in the blockchain data 204, and the blockchain asset data may be stored in the device 102 as off-chain asset data 234. In this example, the device 102 may thus be loaded with an initial balance corresponding to a public address (with the physically unclonable function (PUF) representing the private key) in the blockchain data 204.

At 1202, secure communication between a sending device 102(1) and a receiving device 102(2) may be established via a payment terminal. The payment terminal may be a secure payment terminal 104 or a POS payment terminal 118. The secure communication may be established by exchanging public keys 228, certificates data 232, salt data 238, other data, or any combination thereof.

At 1204, a payment transaction 120 including payment information and a transaction identifier linking the off-chain asset data 234 to a blockchain asset in the block chain is received at the receiving device 102(2) from the sending device 102(1). For example, the sending device 102(1) may send a payment transaction 120 to the receiving device 102(2).

At 1206, a transaction ID settlement model of a plurality of settlement models 224 is determined based on the payment transaction 120. For example, the receiving device 102(2) may select the account settlement model from the settlement models 224(1) based on the payment transaction 120.

At 1208, the transaction identifier that funded the off-chain asset data on the sending device 102(1) is verified to determine that it is present in the blockchain. For example, the receiving device 102(2) send a query including the transaction identifier (transaction ID) to the one or more blockchain servers 202 to verify that the blockchain includes a blockchain asset corresponding to the transaction ID. The one or more blockchain servers 202 may send, to the receiving device 102(2), data including a blockchain address, date information, time information, a value of the blockchain asset, other data, or any combination thereof. The receiving device 102(2) may determine, from the received data, that the blockchain asset associated with the transaction ID is greater than a payment amount in the payment transaction 120. The receiving device 102(2) may verify the balance on the sending device 102(1) based on a copy of the loading transaction including the transaction ID and a transaction hash. It may be difficult to verify a specific blockchain asset because of the nature of blockchain data 204. For example, Bitcoin is defined as the blockchain that has the most work on top of the genesis block created by Satoshi Nakomoto in 2009. However, there have been many forks in the bitcoin blockchain, and there are different blockchain assets that look very similar to one another. Unless a user 106 may holistically verify the blockchain asset, the user 106 may be duped into what is considered the canonical Bitcoin. Therefore, instead of attempting to create a proof of what the blockchain asset is, the transaction ID may be passed to the receiving device 102(2), and the receiving device 102(2) may use the account settlement model to verify that the transaction ID that funded the off-chain asset data 234 on the sending device 102(1) is indeed present in the blockchain data 204.

At 1210, if the payment transaction 120 is invalid (not present on the blockchain), the receiving device 102(2) may refuse to accept the payment transaction, at 1212. Otherwise, at 1210, if the payment transaction 120 is valid (present on the blockchain), the sending device 102(1) may adjust the value of the off-chain asset data 234(1) in the secure memory 618(1) of the sending device 102(1) based on the payment transaction 120, at 1214. At 1216, the receiving device 102(2) may adjust the value of the off-chain asset data 234(2) in the secure memory 618(2) of the receiving device 102(2) based on the payment transaction 120. For example, the sending device 102(1) may update the off-chain asset data by removing the traded asset from its memory, and the receiving device 102(2) may change the value of the off-chain asset data by increasing the value.

Once the presence of the transaction ID on the blockchain is verified by the receiving device 102(2), the receiving device 102(2) may use the selected account settlement model 224 to accept payment from the sending device 102(1) by adjusting the value of the off-chain asset data 234(2) stored in the SCE 218(2). Further, the sending device 102(1) may adjust the value of the off-chain asset data 234(1). To redeem funds back to the blockchain data 204, the receiving device 102(2) may sign a redemption transaction (including a portion of the off-chain asset data 234(2)) with its private key 230(2) and send the signed redemption transaction to the one or more blockchain servers 202.

In this example, the one or more blockchain servers 202 may verify the existence of the underlying transaction IDs that are included in the signed redemption transaction. The account settlement model enables amounts that correspond to single asset types on the blockchain data 204 to be aggregated together when they are redeemed, allowing the redemption process to be cheaper and to be performed in a single redemption transaction. The lowering of cost and the fact that there is less specific identification of each individual asset in that the account settlement payments allow the various payments to be treated as account balances rather than specific assets, allowing the transaction ID settlement model to handle digital currency assets more like change rather than bills as in the UTXO settlement model.

Losses due to a hack or theft may be higher than in the UTXO settlement model because such a theft or loss may affect more than one specific transaction, and the account settlement may negatively influence the balance of the gateway smart contract account. Although transaction balances may be added, each contributing transaction ID may need to be checked to validate the payment settlement, which may make on-chain redemption more expensive. Additionally, there is limited storage space on the receiving device 102(2) so the device 102(2) may be able to hold a finite number of transaction IDs before having to redeem the balance to the blockchain data 204.

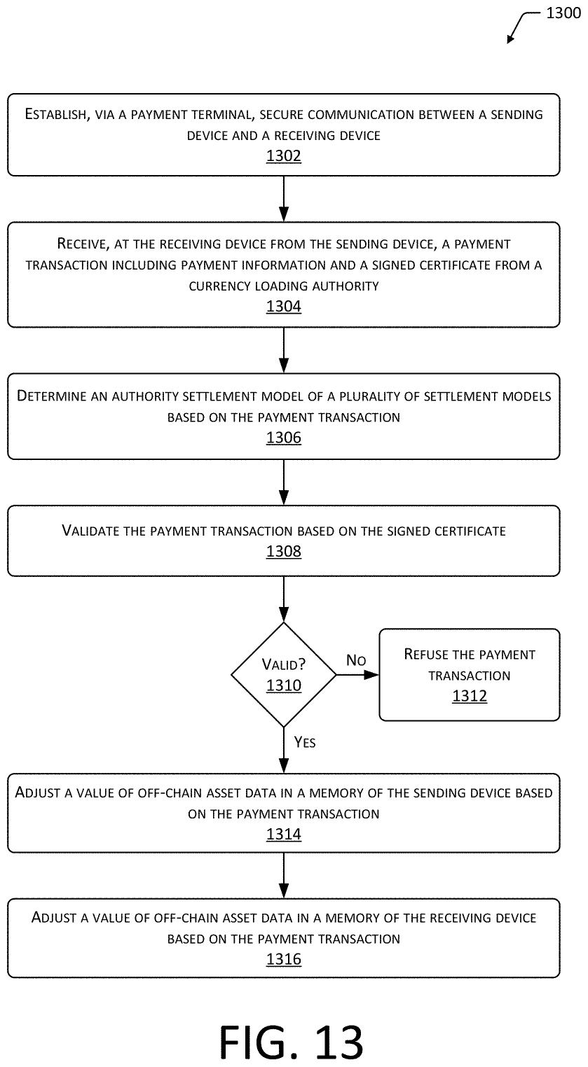

In some implementations, the lack of fungibility of multiple transaction IDs may be ameliorated by having economically incentivized change makers, such as the manufacturer of the device 102, which may store off-chain asset data 234 onto the device 102. The change makers may download off-chain asset data into the smart contract at one time and have other device holders request change from the smart contract, which may be compensated on-chain. These change makers may elect to charge a fee for making change. The benefit to the users 106 is that more of the change may come from a small number of transaction IDs, making the change less expensive to redeem. One possible example of such a settlement model is described below with respect to FIG. 13.

FIG. 13 depicts a flow diagram 1300 of a process of conducting an off-chain digital currency transaction between devices using an authority-based settlement model, according to one implementation. In this example, a trusted authority, such as a bank or other trusted cryptocurrency entity, may download off-chain asset data 234 to a device 102 and provide a signed loading transaction that may be used as a certificate of the authenticity of the download. This type of loading authority transaction allows the recipient device 102 to rely on the signed loading transaction as evidence that the off-chain asset data 234 is real and may be accepted as payment.

At 1302, secure communication between a sending device 102(1) and a receiving device 102(2) may be established via a payment terminal. The payment terminal may be a secure payment terminal 104 or a POS payment terminal 118. The secure communication may be established by exchanging public keys 228, certificates data 232, salt data 238, other data, or any combination thereof.

At 1304, a payment transaction 120 may be received, at the receiving device 102(2) from the sending device 102(1), that includes payment information and a signed certificate from a currency-loading authority. For example, in the authority settlement model, the loading transaction in which the off-chain asset data 234 is loaded onto the sending device 102(1) is signed by an issuing authority, such as the device manufacturer or another authority, or may be made from a specific account. The loading authority may be a trusted entity, such as a corporation, a bank, and so on.

At 1306, an authority settlement model is determined from a plurality of settlement models 224 based on the digitally signed payment. For example, in response to determining the signed certificate from the currency-loading authority is included in the payment transaction 120, the receiving device 102(2) may select the authority settlement model.

At 1308, the payment transaction may be validated based on the signed certificate. The issuing authority signature or specific account signature may prove to other devices 102 that certain off-chain asset data 234 are loaded on the device 102 such that the other devices 102 may trust the loading authority. This means that the counterparty devices (such as the receiving device 102(2)) would not need to verify the existence of a UTXO or transaction ID. Instead, when the sending device 102(1) is loaded, the sending device 102(1) knows that the balance comes from the asset that the loading authority attests to. When a counterparty is taking payment from the sending device 102(1), the counterparty (receiving device 102(2)) may request payment in assets that have been loaded by a trusted loading authority.

The receiving device 102(2) may verify that payment transaction 120 from the sending device 102(1) satisfies the trusted loading authority request by inspecting the signed certificate issued with the payment transaction 120. In some implementations, the receiving device 102(2) may be configured to accept attestations by multiple authorities by adding the public keys 228 of those authorities to the sending device 102(1), for example, in a list of trusted certificates data 236(1). If an authority becomes untrustworthy, the user 106 may remove the key of that authority from the list of trusted certificates data 236(1) of the sending device 102(1) for future transactions, creating an incentive for loading authorities to do a “good” job because a single infraction or misuse of the loading private key 230 may decimate an authority's business.

At 1310, if the signed certificate is not valid, the payment transaction 120 may be refused, at 1312. Otherwise, at 1310, if the signed certificate is valid, the sending device 102(1) adjusts the value of the off-chain asset data 234(1) based on the payment transaction 120, at 1314. For example, the sending device 102(1) may decrease the value of the off-chain asset data 234(1) to reflect the payment transaction. At 1316, the receiving device 102(2) may adjust the value of the off-chain asset data 234(2) in the secure memory 618(2) of the receiving device 102(2) based on the payment transaction 120. For example, the second device 102(2) may increase the value of the off-chain asset data 234(2) by adding the traded asset data to its memory.

In this manifestation, the sending device 102(1) may present the signed certificate and/or signed loading transaction from the loading authority that was used to initialize the device balance to the receiving device 102(2) as part of a payment transaction 120 to prove the appropriate asset type. When a user 106 wants to redeem off-chain asset data to the blockchain, the user 106 may insert the receiving device 102(2) into the device slot 108 of a secure payment terminal 104 to present the loading authority's signature to the corresponding blockchain script or contract, together with a valid device certificate and a request to move funds which are signed by the private key corresponding to the device certificate.

Unlike, the account settlement model 224 that uses transaction IDs to determine asset types (FIG. 11), there may be fewer prevalent loading authorities so the number of transactions that need to be verified may be limited to the number of authorities used, which may be as low as one, even with thousands of transactions and thousands of counterparties. However, in this example, the veracity of the loading authority replaces the transaction-based validation of other settlement models 224.

In general, in an authority model, the authority may make an outgoing transaction from the authority account to an account associated with a device 102(1). Subsequently, the device 102(1) may be coupled to a secure payment terminal 104 to receive the signed transaction from the authority account. The device 102(1) may check that the loading transaction originated from an authority it trusts based on a public key 228 that is already in the trusted certificates data 236(1) on the device 102(1) corresponding to the authority. The device 102(1) may then initialize the off-chain asset data 234(1) for the asset type indicated by the authority to the amount of the loaded transaction. When subsequent transactions are made, only the signed transaction initializing the balance needs to be shared to verify the asset type with a counterparty device, such as the receiving device 102(2). Balances (the values of off-chain asset data 234) stored on the sending device 102(1) and the receiving device 102(2) may be adjusted based on payment transactions 120 exchanged between devices. Subsequently, the off-chain asset data 234 may be redeemed by generating a signed request from the receiving device 102(2) to the loading authority or to an authority-created smart contract. Other implementations are also possible.

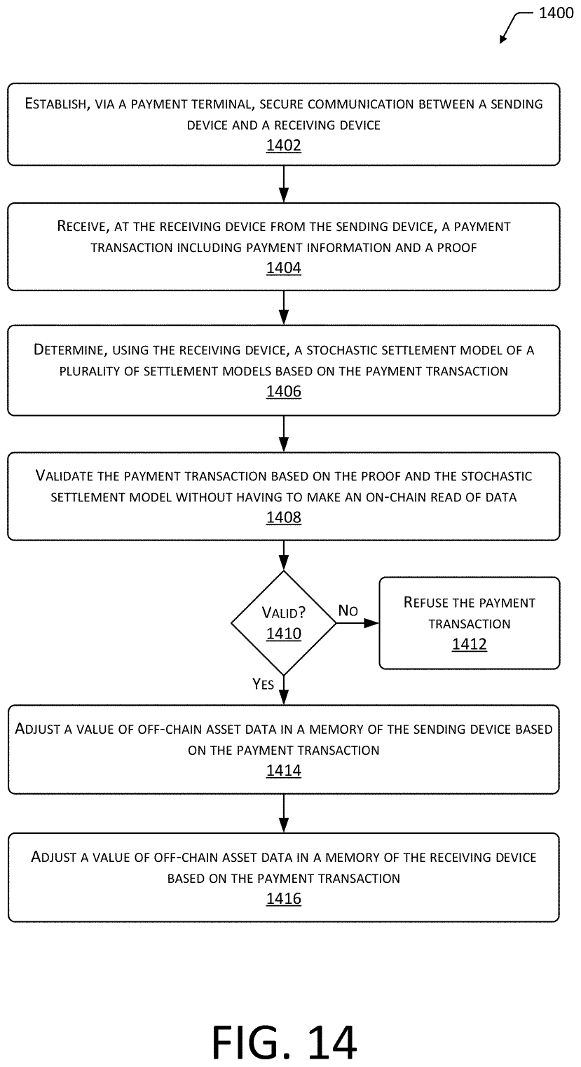

FIG. 14 depicts a flow diagram 1400 of a process of conducting an off-chain digital currency transaction between devices 102 using a stochastic-based settlement model, according to one implementation. At 1402, secure communication between a sending device 102(1) and a receiving device 102(2) may be established via a payment terminal. The payment terminal may be a secure payment terminal 104 or a POS payment terminal 118. The secure communication may be established by exchanging public keys 228, certificates data 232, salt data 238, other data, or any combination thereof.

At 1404, a payment transaction 120 may be received at the receiving device 102(2) from the sending device 102(1), that includes payment information and a proof. For example, the proof may be used in conjunction with a blockchain model determined from the settlement models 224 to validate the payment transaction 120, statistically.

At 1406, a stochastic settlement model may be determined from a plurality of settlement models 224 based on the payment transaction 120. This stochastic settlement model 224 may use a proof that is included in the payment transaction 120 as well as a set of rules or models that are descriptive of specific assets, such that a device 102 may verify the asset generally without having to make an on-chain read of data. For example, the receiving device 102(2) may select the stochastic settlement model from the plurality of settlement models 224 based on data included in the payment transaction 120.

At 1408, the payment transaction may be validated based on the proof and blockchain model without having to make an on-chain read of data. For example, the statistical proof may include a set of hashes that demonstrate that a particular transaction that funded the off-chain asset data 234(1) corresponds to a blockchain asset in a blockchain and that some amount of work was performed on the blockchain asset in the blockchain that may be verified without having to make an on-chain read of data. For example, a proof may include a set of hashes that demonstrate that a transaction identified by the transaction ID was included in a block of the blockchain that had a certain amount of work performed on it after the transaction was made, as well as enough historical information to demonstrate that the underlying blockchain asset is verifiable by its correspondence with the stochastic model. For example, if a proof is made in a completely uncompressed way, the proof of the transaction would include an up-to-date copy of the blockchain data 204. In some implementations, proofs may be made using interlinking hashes, which allow a compressed representation of the blockchain as the proof. For example, proofs may be made using interlinking hashes, which allow the compression of the blockchain. In some implementations, a function may convert data of a block of the blockchain into an encrypted output of a fixed length called a hash. Applied to multiple blocks of the blockchain, the function converts the data of the multiple blocks into compressed versions or hashes that are interlinked by the internal references contained within the blocks. The resulting “interlinking hashes” may be a compressed representation of the blockchain.

The stochastic settlement model describes characteristics of the blockchain data 204 in concise form, which may include a rate of work performed on the blockchain, a block time, a number of transactions per block, historic checkpoints, and other data. Based on the character of the transaction and the associated proof, the underlying blockchain asset for the payment transaction 120 may be ascertained with a high degree of confidence by comparing the proof to the statistical settlement model.

At 1410, if the payment transaction 120 is deemed not to be valid, the payment transaction 120 may be refused, at 1412. Otherwise, at 1410, if the payment transaction 120 is deemed valid, the value of the off-chain asset data 234(1) is adjusted in the memory of the sending device 102(1) based on the payment transaction, at 1414. For example, the receiving device 102(2) may have a list of acceptable proofs that may be used to ascertain a funding transaction's underlying blockchain asset. Within the payment transaction 120, the sending device 102(1) may provide information about the stochastic model that was used to generate the proof, and the receiving device 102(2) may decide to accept payment or not based on the confidence that it has in the proof using the stochastic settlement model from the settlement models 224(2). In the context of a single smart contract which controls the funding transactions for devices 102, only stochastic settlement models that are acceptable to the smart contract would be acceptable by the receiving device 102(2). The stochastic settlement models that are acceptable to the smart contract may be deployed in the smart contract and may also be signed by the issuing entity of the receiving device 102(2).

At 1416, a value of off-chain asset data may be adjusted in a memory of the receiving device 102(2) based on the payment transaction 120. For example, the receiving device 102(2) may increase the value of the off-chain asset data 234(2) based on the payment transaction 120.

It should be understood that the blocks depicted in FIGS. 10-14 are provided for illustrative purposes only. Further, in some instances, blocks may be omitted or combined, and the order may be changed without departing from the scope of the disclosure. For example, in FIG. 14, the sending device 102(1) may adjust the value of the off-chain asset data in its memory in conjunction with sending the payment transaction 120 to the receiving device 102(2). Other implementations are also possible.

The device 102 provides a number of technological advances that enable portability of off-chain asset data 234 downloaded from the blockchain and that enable digital currency transactions off-chain. In particular, the device 102 may include a plurality of settlement models 224, each of which may define rules and information that may be used to verify a particular payment transaction 120 and to resolve the payment transaction 120 off-chain in such a way that they may subsequently be redeemed to the blockchain, because the settlement rules ensure that the blockchain rules are observed and maintained by both the sending device 102(1) and the receiving device 102(2). Further, since the device 102 may manage its own security, establishing secure communication and trust relationships, the device 102 may be used with different types of POS payment terminals 118 and are not limited to use with secure payment terminals 104. Other advantages may also be realized by those skilled in the art upon review of this disclosure.

In conjunction with the devices and systems described above with respect to FIGS. 1-14, a device 102 may establish secure communication and establish a trust relationship by exchanging keys and credentials. The device 102 may manage its own secure communications and validate payment transactions 120 using settlement models 224 without committing the payment transactions 120 to the blockchain and without relying on blockchain consensus protocols.

The settlement models 224 may enable portability of off-chain asset data 234 via the device 102. The device 102 may be used in different contexts, such as at a store at a point of sale, without concern for devices that do not include a secure computing environment and without requiring the transaction costs (both in time and expense) of committing each transaction to the blockchain at the time of the transaction. Instead, the device 102 may validate the payment and adjust the value of the off-chain asset data 234 in the data store 226 of the device 102 using the settlement models 224.

Further, the device 102 enables aggregation of digital currency transactions, causing off-chain asset data 234 of the device 102 to be increased or decreased, accordingly. The aggregated off-chain asset data 234 may then be committed to the blockchain as a single transaction, saving blockchain processing time, increasing the speed with which digital currency transactions may be executed, and reducing the overall expense. Other advantages will also be apparent to those of ordinary skill in the art upon reading the present disclosure.

The processes discussed in this disclosure may be implemented in hardware, software, or a combination thereof. In the context of software, the described operations represent computer-executable instructions stored on one or more computer-readable storage media that, when executed by one or more hardware processors, perform the recited operations. Generally, computer-executable instructions include routines, programs, objects, components, data structures, and the like, that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described in this disclosure. The computer-readable storage medium may be one or more of an electronic storage medium, a magnetic storage medium, an optical storage medium, a quantum storage medium, and so forth. For example, the computer-readable storage media may include, but is not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of transitory machine-readable signals, whether modulated using a carrier or unmodulated, include, but are not limited to, signals that a computer system or machine hosting or running a computer program may be configured to access, including signals transferred by one or more networks. For example, the transitory machine-readable signal may comprise transmission of software by the Internet.

Separate instances of these programs may be executed on or distributed across any number of separate computer systems. Although certain steps have been described as being performed by certain devices, software programs, processes, or entities, this need not be the case, and a variety of alternative implementations will be understood by those having ordinary skill in the art.

Additionally, those having ordinary skill in the art will readily recognize that the techniques described above may be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

### Clauses

The following clauses describe additional implementations.
1. A device comprising:

a communication interface to communicate with a network;

one or more memory devices to store off-chain asset data, a plurality of settlement models, and processor-executable instructions, the off-chain asset data including blockchain data downloaded from a blockchain asset in a blockchain; and

one or more processors to execute the processor-executable instructions to:
establish, using the communication interface, secure communication with a second device;
receive a payment transaction including payment information corresponding to off-chain asset data stored in the second device;
determine a settlement model of the plurality of settlement models based on the payment transaction, wherein the settlement model defines a set of rules for validating the payment transaction without committing the payment transaction to the blockchain;
determine payment information included in the payment transaction is valid using the determined settlement model; and
adjust a value of the off-chain asset data stored in the one or more memory devices in response to determining the payment information is valid.
2. The device of clause 1, wherein:

the payment information includes a private key of the second device; and

the one or more processors executing the processor-executable instructions to:
determine, from the payment information, the private key is a bearer asset indicative of ownership of the blockchain asset; and
   search the blockchain, using the determined settlement model, to confirm that the private key is associated with the blockchain asset in the blockchain.
3. The device of any of clauses 1 or 2, wherein:

the payment information includes an unspent transaction output (UTXO) and first data; and

the one or more processors executing the processor-executable instructions to determine, using the determined settlement model, that the UTXO is unspent by searching the blockchain.
4. The device of any of clauses 1, 2, or 3, wherein:

the payment information includes a transaction ID; and

the one or more processors executing the processor-executable instructions to:
send a query including the transaction ID to one or more blockchain servers;
receive, from the one or more blockchain servers, data corresponding to the blockchain asset in the blockchain, the received data includes a blockchain address, time information, date information, and a value associated with the blockchain asset; and
determine, using the determined settlement model, the payment information includes a payment amount that is less than a value of the blockchain asset based on the received data.
5. The device of any of clauses 1, 2, 3, or 4, wherein:

the payment information includes a signed certificate of a loading authority; and
the one or more processors executing the processor-executable instructions to determine the signed certificate is in a list of trusted certificates.
6. The device of any of clauses 1, 2, 3, 4, or 5, wherein the payment information includes a proof, the proof including interlinking hashes representing a compressed version of the blockchain.
7. The device of any of clauses 1, 2, 3, 4, 5 or 6, the one or more processors executing the processor-executable instructions to:

receive an input; and

in response to the input, send a redemption transaction including a value related to the off-chain asset data through the communication interface to a blockchain server.
8. The device of any of clauses 1, 2, 3, 4, 5, 6, or 7, the one or more processors executing the processor-executable instructions to:

receive an input; and

in response to the input, send a payment transaction through the communication interface to a second device, the payment transaction including payment information based on the off-chain asset data.
9. A method comprising:

establishing, using a communication interface of a first device, secure communication with a second device;

receiving, at the first device, a payment transaction from the second device, the payment transaction including payment information corresponding to off-chain asset data stored in a memory of the second device and including associated data;

determining, using the first device, a settlement model from a plurality of settlement models based on the payment information, wherein the determined settlement model comprises a set of rules for determining the payment transaction is valid based on the associated data;

determining, using the determined settlement model, that the payment information corresponds to a blockchain asset in a blockchain; and

adjusting a value of off-chain asset data stored in a memory of the first device based on the payment information.
10. The method of clause 9, further comprising:

determining a private key within the payment information;

determining the private key is a bearer asset indicative of ownership of the blockchain asset based on the determined settlement model; and

querying the blockchain, using the determined settlement model, to confirm that the private key corresponds to the blockchain asset in the blockchain.
11. The method of clause 9 or 10, further comprising:

determining an unspent transaction output (UTXO) and first data within the payment information; and

determining, using the determined settlement model, that the UTXO is unspent in the blockchain.
12. The method of any of clauses 9, 10, or 11, further comprising determining a transaction identifier and a transaction hash within the payment information.
13. The method of any of clauses 9, 10, 11 or 12, further comprising:

determining a signed certificate associated with a loading authority within the payment information; and

determining, using the determined settlement model, the signed certificate corresponds to one of a plurality of trusted certificates in the memory of the first device.
14. The method of any of clauses 9, 10, 11, 12, or 13, further comprising determining a proof within the payment information, the proof including interlinking hashes representing a compressed version of the blockchain.
15. The method of any of clauses 9, 10, 11, 12, 13, or 14, further comprising:

sending a payment transaction including a portion of the off-chain asset data to another device or to a blockchain server; and

wherein the value of the off-chain asset data is adjusted based on the portion.
16. A device comprising:

a communication interface;

one or more memory devices to store off-chain asset data, a plurality of settlement models, and processor-executable instructions, the off-chain asset data including blockchain data downloaded from a blockchain asset in a blockchain; and

one or more processors to execute the processor-executable instructions to:
receive, from a second device via the communication interface, a payment transaction including payment information corresponding to off-chain asset data stored by the second device;
determine a settlement model from the plurality of settlement models based on the payment information, the determined settlement model defining a set of rules to verify the payment transaction without committing the payment transaction to the blockchain;
determine the payment information is valid using the determined settlement model; and
adjust a value of the off-chain asset data stored in the one or more memory devices based on the payment information in response to verification of the payment information.
17. The device of clause 16, the processor-executable instructions cause the one or more processors to:

determine a private key within the payment information;

determine, from the payment information, the private key is a bearer asset indicative of ownership of the blockchain asset; and

search the blockchain, using the determined settlement model, to confirm that the private key is associated with the blockchain asset in the blockchain.
18. The device of clause 16 or 17, the processor-executable instructions cause the one or more processors to:

determine an unspent transaction output (UTXO) and first data within the payment information; and

determine, using the determined settlement model, whether the UTXO is unspent in the blockchain.
19. The device of any of clauses 16, 17, or 18, the processor-executable instructions cause the one or more processors to:

determine a transaction identifier (ID) within the payment information; and

determine, using the determined settlement model, a blockchain asset in the blockchain that corresponds to the transaction ID.
20. The device of any of clauses 16, 17, 18, or 19, the processor-executable instructions cause the one or more processors to:

determine a certificate of a loading authority within the payment information; and

determine, using the determined settlement model, the certificate is valid by searching a list of trusted certificates in the one or more memory devices.
21. The device of any of clauses 16, 17, 18, 19, or 20, the processor-executable instructions cause the one or more processors to determine a proof within the payment information, the proof including a plurality of interlinking hashes representing a compressed version of the blockchain.

What is claimed is:

1. A device comprising:
a communication interface to communicate with a network;
one or more memory devices to store off-chain asset data, a plurality of settlement models, and processor-executable instructions, the off-chain asset data including blockchain data downloaded from a blockchain asset in a blockchain; and
one or more processors to execute the processor-executable instructions to:
establish, using the communication interface, secure communication with a second device;
receive a payment transaction including payment information corresponding to off-chain asset data stored in the second device;
determine a settlement model of the plurality of settlement models based on the payment transaction, wherein the settlement model defines a set of rules for validating the payment transaction without committing the payment transaction to the blockchain;
determine payment information included in the payment transaction is valid using the determined settlement model; and
adjust a value of the off-chain asset data stored in the one or more memory devices in response to determining the payment information is valid.

2. The device of claim 1, wherein:
the payment information includes a private key of the second device; and
the one or more processors executing the processor-executable instructions to:
determine, from the payment information, the private key is a bearer asset indicative of ownership of the blockchain asset; and
search the blockchain, using the determined settlement model, to confirm that the private key is associated with the blockchain asset in the blockchain.

3. The device of claim 1, wherein:
the payment information includes an unspent transaction output (UTXO) and first data; and
the one or more processors executing the processor-executable instructions to determine, using the determined settlement model, that the UTXO is unspent by searching the blockchain.

4. The device of claim 1, wherein:
the payment information includes a transaction ID; and
the one or more processors executing the processor-executable instructions to:
send a query including the transaction ID to one or more blockchain servers;
receive, from the one or more blockchain servers, data corresponding to the blockchain asset in the blockchain, the received data includes a blockchain address, time information, date information, and a value associated with the blockchain asset; and
determine, using the determined settlement model, the payment information includes a payment amount that is less than a value of the blockchain asset based on the received data.

5. The device of claim 1, wherein:
the payment information includes a signed certificate of a loading authority; and
the one or more processors executing the processor-executable instructions to determine the signed certificate is in a list of trusted certificates.

6. The device of claim 1, wherein the payment information includes a proof, the proof including interlinking hashes representing a compressed version of the blockchain.

7. The device of claim 1, the one or more processors executing the processor-executable instructions to:
receive an input; and
in response to the input, send a redemption transaction including a value related to the off-chain asset data through the communication interface to a blockchain server.

8. The device of claim 1, the one or more processors executing the processor-executable instructions to:
receive an input; and
in response to the input, send a payment transaction through the communication interface to a second device, the payment transaction including payment information based on the off-chain asset data.

9. A method comprising:
establishing, using a communication interface of a first device, secure communication with a second device;
receiving, at the first device, a payment transaction from the second device, the payment transaction including payment information corresponding to off-chain asset data stored in a memory of the second device and including associated data;
determining, using the first device, a settlement model from a plurality of settlement models based on the payment information, wherein the determined settlement model comprises a set of rules for determining the payment transaction is valid based on the associated data;
determining, using the determined settlement model, that the payment information corresponds to a blockchain asset in a blockchain; and
adjusting a value of off-chain asset data stored in a memory of the first device based on the payment information.

10. The method of claim 9, further comprising:
determining a private key within the payment information;
determining the private key is a bearer asset indicative of ownership of the blockchain asset based on the determined settlement model; and
querying the blockchain, using the determined settlement model, to confirm that the private key corresponds to the blockchain asset in the blockchain.

11. The method of claim 9, further comprising:
determining an unspent transaction output (UTXO) and first data within the payment information; and
determining, using the determined settlement model, that the UTXO is unspent in the blockchain.

12. The method of claim 9, further comprising determining a transaction identifier and a transaction hash within the payment information.

13. The method of claim 9, further comprising:
determining a signed certificate associated with a loading authority within the payment information; and
determining, using the determined settlement model, the signed certificate corresponds to one of a plurality of trusted certificates in the memory of the first device.

14. The method of claim 9, further comprising determining a proof within the payment information, the proof including interlinking hashes representing a compressed version of the blockchain.

15. The method of claim 9, further comprising:
sending a payment transaction including a portion of the off-chain asset data to another device or to a blockchain server; and
wherein the value of the off-chain asset data is adjusted based on the portion.

16. A device comprising:
a communication interface;
one or more memory devices to store off-chain asset data, a plurality of settlement models, and processor-executable instructions, the off-chain asset data including blockchain data downloaded from a blockchain asset in a blockchain; and
one or more processors to execute the processor-executable instructions to:
receive, from a second device via the communication interface, a payment transaction including payment information corresponding to off-chain asset data stored by the second device;
determine a settlement model from the plurality of settlement models based on the payment information, the determined settlement model defining a set of rules to verify the payment transaction without committing the payment transaction to the blockchain;
determine the payment information is valid using the determined settlement model; and
adjust a value of the off-chain asset data stored in the one or more memory devices based on the payment information in response to verification of the payment information.

17. The device of claim 16, the processor-executable instructions cause the one or more processors to:
determine a private key within the payment information;
determine, from the payment information, the private key is a bearer asset indicative of ownership of the blockchain asset; and
search the blockchain, using the determined settlement model, to confirm that the private key is associated with the blockchain asset in the blockchain.

18. The device of claim 16, the processor-executable instructions cause the one or more processors to:
determine an unspent transaction output (UTXO) and first data within the payment information; and
determine, using the determined settlement model, whether the UTXO is unspent in the blockchain.

19. The device of claim 16, the processor-executable instructions cause the one or more processors to:
determine a transaction identifier (ID) within the payment information; and
determine, using the determined settlement model, a blockchain asset in the blockchain that corresponds to the transaction ID.

20. The device of claim 16, the processor-executable instructions cause the one or more processors to:
determine a certificate of a loading authority within the payment information; and
determine, using the determined settlement model, the certificate is valid by searching a list of trusted certificates in the one or more memory devices.

21. The device of claim 16, the processor-executable instructions cause the one or more processors to determine a proof within the payment information, the proof including a plurality of interlinking hashes representing a compressed version of the blockchain.
